(19) United States
(12) Patent Application Publication
(10) Pub. No.: US 2026/0065182 A1
(43) Pub. Date: Mar. 5, 2026

(54) AGRICULTURAL LAND ISSUE MANAGEMENT SYSTEM, AND METHOD THEREOF

(71) Applicant: AGRICULTURAL CORPORATION IOCROPS INC., Pohang-si (KR)

(72) Inventors: Jinhyung CHO, Seoul (KR); Sohee SIM, Seoul (KR); Kyeong Seo LEE, Seoul (KR)

(73) Assignee: AGRICULTURAL CORPORATION IOCROPS INC., Pohang-si (KR)

(21) Appl. No.: 19/383,972

(22) Filed: Nov. 10, 2025

Related U.S. Application Data
(63) Continuation of application No. PCT/KR2024/006193, filed on May 8, 2024.

(30) Foreign Application Priority Data
May 8, 2023 (KR) 10-2023-0059368
May 2, 2024 (KR) 10-2024-0058387

(51) Int. Cl. G06Q 10/0631; G06Q 50/02

(52) U.S. Cl. CPC G06Q 10/063114; G06Q 50/02

(57) ABSTRACT

The present invention relates to an issue management system including a manager terminal, a worker terminal, and a server. The server classifies and stores first issue occurrence information as an unidentified issue until an issue registration determination for the first issue occurrence information is received from the manager terminal, and an emergency indicator indicating emergency is displayed together in an issue item indicating issue occurrence information including emergency.

### CROSS-REFERENCE TO RELATED APPLICATIONS

This application is a continuation of International Application No. PCT/KR2024/006193 filed on May 8, 2024, which claims priority to Korean Patent Application No. 10-2023-0059368 filed on May 8, 2023 and Korean Patent Application No. 10-2024-0058387 filed on May 2, 2024, the entire contents of which are herein incorporated by reference.

### TECHNICAL FIELD

The present disclosure relates to a system and method for managing issues arising in a farming area and, more particularly, to a farming area issue management system and a method thereof in which a worker terminal generates information on issues arising in a farming area, and a manager terminal determines whether to register the information on the issues (hereinafter, referred to as the issue occurrence information).

### Background Art

When crops are grown in large farms or greenhouses, it is required to discover issues such as facility failures or pests and diseases quickly and respond appropriately to the issues. If prompt actions are not taken, the issues arising in a specific zone can cause damage to all the crops, leading to significant economic losses.

To prevent such a problem, farming area managers who work on farms or in greenhouses, etc. have been managing issues such as facility failures or pests and diseases while they go around all zones of a farming area. However, in this regard, the larger the zones of the farming area, the more managers are needed, resulting in excessive labor costs, or for practical reasons, when issue management in the farming area is not properly performed and problems arise, the managers used to take follow-up measures for resolving the problems as they arose.

Meanwhile, workers who directly grow crops on a large farm or in a greenhouse typically outnumber managers, and the workers move around various zones of the farming area to perform assigned work.

Accordingly, there have been attempts to use information obtained from the workers to improve farming area management by way of providing the workers with programs and the like that allow the workers to register issues such as facility failures or pests and diseases while they go around the farming area.

However, since the workers having less specialized knowledge about farms or greenhouses are unable to accurately determine the issues such as the facility failures or pests and diseases, unreliable information on issues increases when the farms or greenhouses are managed on the basis of the issues registered by the workers, and thus information about the issues is not properly managed, causing problems such as spraying pesticides in unrequired locations or hiring repair personnel even when facilities are not actually broken.

Thus, in order to maximally increase economic benefits in managing a farming area, it is required to develop a system for managing issues within the farming area with guaranteed reliability.

### SUMMARY

### Technical Problem

An objective of the present disclosure is to provide a system and method for quickly and reliably managing issues across all farming area by allowing workers, who move around various zones of the farming area such as a farm and a greenhouse to perform tasks, to easily generate issue occurrence information on issues arising in the farming area, and also allowing a manager with expertise in farming area management to easily determine whether to register the issue occurrence information.

Another objective of the present disclosure is to provide a system and method in which when an issue occurrence status page reflecting issue occurrence information is provided to a manager, an unconfirmed issue is classified and displayed and the issue occurrence status page whose urgent issue is displayed together with a separate indicator is provided to the manager, thereby enabling the manager to easily manage an agricultural problem without missing any issues.

The problem to be solved in the embodiment of the present disclosure is not limited to the above-described problems, and the problems not mentioned will be clearly understood by those skilled in the art to which the present disclosure belongs from the present specification and the accompanying drawings.

### Technical Solution

According to the exemplary embodiment of the present disclosure, there is provided an issue management system including a manager terminal, a worker terminal, and a server, the system including: at least one worker terminal assigned to a worker who is guided to perform work within a greenhouse according to a preset schedule; at least one manager terminal assigned to a manager who oversees a state of the work within the greenhouse and a progress of the work within the greenhouse; and the server communicatively connected to the worker terminal and the manager terminal and configured to store and manage information about the greenhouse, wherein the worker terminal is configured to transmit first issue occurrence information generated according to a first input of a user to the server, the first issue occurrence information at least includes one of a type of issue, an occurrence location of an issue, a photo related to the issue, and an urgency status of the issue, the first input is obtained through an issue input interface provided on the worker terminal, the server is configured to store the first issue occurrence information received from the at least one worker terminal, classify, as an unconfirmed issue, and store the first issue occurrence information until an issue registration determination for the first issue occurrence information is received from the manager terminal, and provide one or more pieces of the stored issue occurrence information to the manager terminal in response to a trigger received from the manager terminal, the manager terminal is configured to display an issue occurrence status page reflecting the one or more pieces of the provided issue occurrence information, one or more issue items representing the one or more pieces of the issue occurrence information are displayed on the issue occurrence status page, the one or more issue items are classified and displayed according to the type, an issue item indicating issue occurrence information classified as the unconfirmed issue is classified as the unconfirmed issue and displayed despite the type, and an issue item indicating issue occurrence information including an urgency is displayed along with an urgency indicator indicating the urgency.

The problem solutions of the present disclosure are not limited to the above-described solutions, and solutions that are not mentioned may be clearly understood to those skilled in the art to which the present disclosure belongs from the present specification and the accompanying drawings.

### Advantageous Effects

According to the present disclosure, workers who move around various zones of a farming area such as a farm and a greenhouse to perform tasks may easily generate issue occurrence information on issues arising in the farming area, and a manager with expertise in farming area management may easily determine whether to register the issue occurrence information, thereby quickly and reliably managing issues across all the farming area.

In addition, according to the present disclosure, when an issue occurrence status page reflecting issue occurrence information is provided to a manager, unconfirmed issues are classified and displayed separately and the issue occurrence status page whose urgent issue is displayed together with a separate indicator is provided to the manager, whereby the manager may flexibly manage the issues in a farming area in order of priority while maximally reducing damage.

The effectiveness of the present disclosure is not limited to the above-described effectiveness, and effectiveness not mentioned herein may be clearly understood by those skilled in the art to which the present disclosure belongs from the present specification and the accompanying drawings.

### DESCRIPTION OF DRAWINGS

FIG. 1 is a view illustrating a farming environment in a farming area.

FIGS. 2 and 3 are views each illustrating an issue management system according to one exemplary embodiment.

FIG. 4 is a view illustrating a configuration of a worker terminal according to one exemplary embodiment.

FIGS. 5 and 6 are views each illustrating an issue input page according to one exemplary embodiment.

FIG. 7 is a view illustrating a configuration of a manager terminal according to one exemplary embodiment.

FIGS. 8 to 14 are views each illustrating an issue status page according to one exemplary embodiment.

FIGS. 15 to 19 are views each illustrating an issue detail page according to one exemplary embodiment.

FIG. 20 is a view illustrating a configuration of a server according to one exemplary embodiment.

FIGS. 21 to 26 are flowcharts each illustrating an issue management method according to one exemplary embodiment.

### DETAILED DESCRIPTION OF THE INVENTION

Exemplary embodiments described in the present specification are intended to clearly describe the idea of the present disclosure to those skilled in the art. Therefore, the present disclosure is not limited by the exemplary embodiments, and the scope of the present disclosure should be interpreted as encompassing modifications and variations without departing from the idea of the present disclosure.

Terms used in the present specification are selected from among general terms, which are currently widely used, in consideration of functions in the present disclosure and may have meanings varying depending on intentions of those skilled in the art, customs in the field of art, the urgency of new technologies, or the like. However, in contrast, in a case where a specific term is defined and used with an arbitrary meaning, the meaning of the term will be described separately. Accordingly, the terms used in the present specification should be interpreted on the basis of the actual meanings and the whole context throughout the present specification rather than on the basis of just names for the terms.

The accompanying drawings are intended to easily describe the present disclosure, and shapes indicated in the drawings may be exaggerated as necessary in order to aid in understanding the present disclosure. Therefore, the present disclosure is not limited by the drawings.

When it is determined that detailed descriptions of well-known components or functions related to the present disclosure may obscure the subject matter of the present disclosure, detailed descriptions thereof may be omitted herein as necessary.

According to the exemplary embodiment of the present disclosure, there is provided an issue management system including a manager terminal, a worker terminal, and a server, the system including: at least one worker terminal assigned to a worker who is guided to perform work within a greenhouse according to a preset schedule; at least one manager terminal assigned to a manager who oversees a state of the work within the greenhouse and a progress of the work within the greenhouse; and the server communicatively connected to the worker terminal and the manager terminal and configured to store and manage information about the greenhouse, wherein the worker terminal may be configured to transmit first issue occurrence information generated according to a first input of a user to the server, the first issue occurrence information at least may include one of a type of issue, an occurrence location of an issue, a photo related to the issue, and an urgency status of the issue, the first input may be obtained through an issue input interface provided on the worker terminal, the server may be configured to store the first issue occurrence information received from the at least one worker terminal, classify, as an unconfirmed issue, and store the first issue occurrence information until an issue registration determination for the first issue occurrence information is received from the manager terminal, and provide one or more pieces of the stored issue occurrence information to the manager terminal in response to a trigger received from the manager terminal, the manager terminal may be configured to display an issue occurrence status page reflecting the one or more pieces of the provided issue occurrence information, one or more issue items representing the one or more pieces of the issue occurrence information may be displayed on the issue occurrence status page, the one or more issue items may be classified and displayed according to the type, an issue item indicating issue occurrence information classified as the unconfirmed issue may be classified as the unconfirmed issue and displayed despite the type, and an issue item indicating issue occurrence information including an urgency may be displayed along with an urgency indicator indicating the urgency.

When a first issue item based on a second input of the user is selected, the manager terminal may display an issue detail page for the first issue item, and the issue detail page may display the type, the occurrence location, and the photo, which are corresponding to the selected first issue item.

When the first issue item is an issue item classified as the unconfirmed issue, the issue detail page may be further provided with an issue registration interface, the manager terminal may transmit an issue registration determination to the server when obtaining the issue registration determination for the first issue item through the issue registration interface, and the server may reclassify, as a registered issue, the issue occurrence information classified as the unconfirmed issue corresponding to the first issue item.

When the first issue item is an issue item indicating issue occurrence information classified as the registered issue, the issue detail page is further provided with an issue resolution interface, the manager terminal may transmit an issue resolution determination to the server when obtaining the issue resolution determination for the first issue item through the issue resolution interface, and the server may reclassify, as a resolved issue, the issue occurrence information classified as the registered issue corresponding to the first issue item.

The issue items indicating the issue occurrence information classified as the resolved issue may be classified as the resolved issue and displayed on the issue occurrence status page despite the type.

The manager terminal may transmit second issue occurrence information generated according to a third input of the user to the server, the second issue occurrence information may include at least the type of issue and the occurrence location of the issue, the third input may be obtained through the issue input interface provided on the manager terminal, and the server may store the second issue occurrence information received from the manager terminal, but classify, as the registered issue, and store the second issue occurrence information even though the issue registration determination for the second issue occurrence information is not received.

The issue input interface may include: an occurrence location selection interface of the issue; a type selection interface of the issue; a photo input interface related to the issue; an urgency selection interface of the issue; and a description input interface related to the issue.

The interface for selecting the occurrence location may be deactivated when there is location information corresponding to a QR code obtained through the worker terminal.

The occurrence location selection interface may be provided to display a preset list of locations so that one of the locations is selected.

The occurrence location selection interface may include at least one of: a zone selection interface provided to display preset zone tabs so that one of the zone tabs is selected; a line selection interface provided to display a preset list of lines existing within a zone so that one of the lines existing within the zone is selected; and a line-based location selection interface provided to display preset approximate location tabs within a line so that one of the approximate location tabs within the line is selected.

The type selection interface may be provided to display preset issue type tabs so that one of the issue type tabs is selected, the photo input interface may be provided to input the photo obtained from a photographing module of the worker terminal, the urgency selection interface may be provided to display preset urgency setting tabs so that one of the urgency setting tabs is selected, and the description input interface may be provided to input a message through an input unit of the worker terminal.

The type may at least include pests and diseases, as well as facility failures, and an issue item indicating issue occurrence information classified as unconfirmed, an issue item indicating issue occurrence information regarding the pests and diseases, and an issue item indicating issue occurrence information regarding the facility failures may be classified and displayed in the issue occurrence status page.

Among the one or more pieces of the issue occurrence information, the number of pieces of the issue occurrence information classified as the unconfirmed issue and the number of pieces of the issue occurrence information by type may be classified and displayed in the issue occurrence status page.

The occurrence location may be classified for each zone within the greenhouse, and the one or more issue items may be classified and displayed for each zone in the issue occurrence status page.

The issue occurrence information may further include a generation date of the issue, and the issue occurrence status page separately may display an issue item indicating issue occurrence information including the urgency and whose generation date is the current date, among the one or more pieces of the issue occurrence information.

The manager terminal may display an issue detail page for a second issue item when the second issue item is selected according to a fourth input of the user, the issue detail page may be provided with a reminder settings interface, the manager terminal may transmit reminder date information to the server when obtaining the reminder date information for the second issue item through the reminder settings interface, and the server may set a reminder including the reminder date information in the issue occurrence information corresponding to the second issue item.

In the issue occurrence status page, a reminder indicator may be displayed together with an issue item indicating issue occurrence information for which the reminder is set.

The manager terminal may provide an alarm when there is issue occurrence information, for which the reminder is set and including the reminder date information corresponding to the current date, among the one or more pieces of the issue occurrence information.

The manager terminal may display an issue detail page for a third issue item when the third issue item is selected according to a fifth input of the user, the issue detail page may be provided with a message input interface, the manager terminal may transmit an additional message to the server when obtaining the additional message for the third issue item through the message input interface, and the server may include the additional message in issue occurrence information corresponding to the third issue item.

The issue detail page may display the additional message included in the issue occurrence information corresponding to the third issue item.

1. Farming Environment in Farming area Below, a farming environment within a farming area is described.

The farming area according to the present disclosure may mean a farm or a greenhouse for growing crops. However, this is not limited thereto, and the farming area may refer to a specific zone that is set aside for growing the crops.

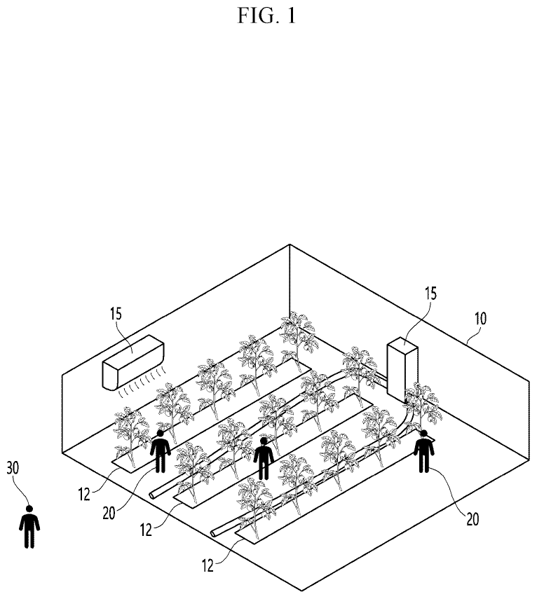

(1) Farming Area FIG. 1 is a view illustrating a farming environment in a farming area 10.

Referring to FIG. 1, crops 12 and facilities 15 may be placed within the farming area 10.

According to the present disclosure, the crops 12 may mean crops to be grown in the farming area 10. For example, the crops 12 may mean crops of cereals, grains, vegetables, and/or fruits, despite types thereof, such as rice, wheat, corn, potatoes, beans, paprika, strawberries, tomatoes, and/or cucumbers.

The crops 12 according to the present disclosure may be cultivated in preset locations within the farming area 10.

For example, the crops 12 may be placed and grown in preset zones within the farming area 10. In this case, a plurality of zones may be set within the farming area 10.

For another example, the crops 12 may be placed and grown in preset lines within the farming area 10. In this case, a plurality of lines may be set within the farming area 10. Alternatively, a plurality of lines may be set in a specific zone within the farming area 10.

Referring to FIG. 1, the facilities 15 may be arranged within the farming area 10.

The facilities 15 according to the present disclosure may mean devices for operating the farming area 10 and/or devices for managing the crops 12. For example, an air conditioner for managing the air in the farming area 10, a pump for watering the crops 12, and/or a temperature measuring device for detecting the temperature of the farming area 10 may be arranged within the farming area 10. Meanwhile, the types of facilities 15 are not limited to the examples described above, and may include various facilities, devices, and/or instruments, etc. for maintenance, management, protection, improvement, and/or cultivation of the farming area 10 and/or the crops 12.

### (2) Worker

Referring to FIG. 1, a worker 20 performing work within a farming area 10 may be placed in the farming area 10.

For example, the worker 20 performing farm work on the crops 12 may be deployed in the farming area 10. For another example, the worker 20 for performing work of operating and/or managing the facilities 15 may be deployed in the farming area 10. The work performed by the worker 20 is not limited to the above-described examples, and may include various types of work within the farming area 10.

The worker 20 according to the present disclosure may perform work in the farming area 10 according to a predetermined schedule. In this case, the schedule may be determined by a manager 30 described later, but is not limited thereto.

The worker 20 according to the present disclosure may recognize an issue within the farming area 10 and report the issue to the manager 30. The worker 20 may use an issue management system to report the issue. The specific details regarding the issue management system are described later.

An issue according to the present disclosure may refer to a problem arising within the farming area 10.

For example, an issue may mean a problem occurring in the crops 12. For a more specific example, the issue may mean a state in which the crops 12 are infested with pests and diseases.

For another example, an issue may mean a problem occurring in the facilities 15. For a more specific example, the issue may mean a state in which a humidity control device is broken.

As a yet another example, an issue may refer to a problem occurring in the farming area 10. For a more specific example, the issue may mean a state in which the glass that is a side wall of a glass greenhouse is broken.

The issues are not limited to the above-described examples, and issues may refer to various types of problems, such as temporary or permanent damage to the crops 12 or reduced work efficiency of the worker when work is performed in the farming area 10.

Meanwhile, according to the present disclosure, one or more workers 20 may be deployed in the farming area 10.

### (3) Manager

Referring to FIG. 1, a manager 30 who manages the farming area 10 may be placed in the farming area 10.

The manager 30 according to the present disclosure may oversee work state and/or work progress within the farming area 10. For example, the manager 30 may set work zones for the workers 20, generate a work schedule, instruct the workers on work, check and/or evaluate the work state of the workers, or monitor the status of the farming area 10. The work performed by the manager 30 is not limited to the examples described above, and the manager 30 may perform various kinds of work related to the farming area 10 in a way that may increase profits from the farming area 10.

The manager 30 according to the present disclosure may use an issue management system to manage issues within the farming area 10. The specific details regarding the issue management system are described later.

Meanwhile, one manager 30 may be assigned to the farming area 10. This is not limited thereto, and one or more manager 30 may be assigned to one a farming area 10.

### 2. Issue Management System

Below, an issue management system and a method thereof according to one exemplary embodiment are described.

### (1) Components of Issue Management System

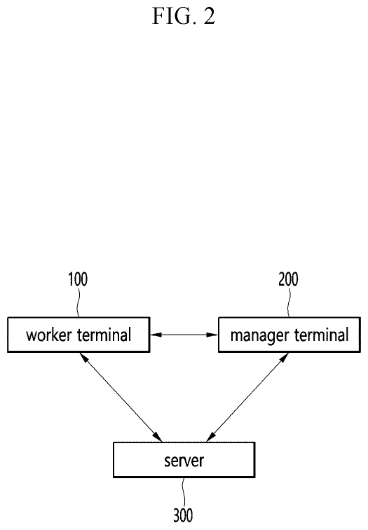

FIG. 2 is a view illustrating an issue management system according to one exemplary embodiment.

Referring to FIG. 2, the issue management system according to one exemplary embodiment may include a worker terminal 100, a manager terminal 200, and a server 300. The issue management system may manage issues occurring in a farming area by using the worker terminal 100, the manager terminal 200, and the server 300.

### (2) Main Functions of Worker Terminal

The worker terminal 100 according to the present disclosure means a terminal assigned to a worker.

For example, the worker terminal 100 may mean a terminal provided directly to the worker. For another example, the worker terminal 100 may mean a terminal logged in with a worker's ID. In this case, the worker ID may be an ID assigned to each worker or an ID assigned to a worker group. It is not limited thereto, and the worker terminal 100 may refer to various types of terminals that can be used by the worker.

The worker terminal 100 may be used by a worker to perform work. Since the details related to the worker's work have been described above in 1. Farming Environment in Farming Area, a duplicate description will be omitted.

For example, the worker terminal 100 may be used by the worker to check a work schedule, check details of work to be performed, record the details of work performed, or check a location where the work will be performed.

For a specific example, the worker terminal 100 may recognize a Quick Response code (a QR code) provided for each crop location in a farming area, so as to check details of work, record the details of work performed, or identify a current location.

For another example, the worker terminal 100 may be used to register an issue discovered by the worker in the farming area to a server. Since the details related to the issues have been described above in 1. Farming Environment in Farming Area, a duplicate description will be omitted. Details regarding registering the issue in the issue management system are provided below.

The details of using the worker terminal 100 are not limited to the above-described example, and the worker terminal 100 may perform various operations to assist the worker in performing the work.

The worker terminal 100 may transmit information related to work and/or information related to an issue to the server 300 or receive information from the server 300.

### (3) Main Functions of Manager Terminal

The manager terminal 200 according to the present disclosure means a terminal assigned to a manager.

For example, the manager terminal 200 may mean a terminal provided directly to the manager. For another example, the manager terminal 200 may mean a terminal logged in with a manager's ID. In this case, the manager's ID may be an ID assigned to each manager or an ID assigned to a manager group. This is not limited thereto, and the manager terminal 200 may refer to various types of terminals that can be used by the manager.

The manager terminal 200 may be used by the manager to perform work. Since the details related to the manager's work have been described above in 1. Farming Environment in Farming Area, a duplicate description will be omitted.

For example, the manager terminal 200 may be used by the manager to check the status of work in the farming area, check the progress of the work, instruct a worker to perform work state, or create a work schedule.

For another example, the manager terminal 200 may be used by the manager to check, register, and manage issues within the farming area. Since the details related to the issues have been described above in 1. Farming Environment in Farming Area, a duplicate description will be omitted. Details on checking, registering, and managing the issues are provided below.

The details of the manager terminal 200 are not limited to the examples described above, and the manager terminal 200 may perform various operations to assist the manager's work.

The manager terminal 100 may transmit information related to work and/or information related to issues to the server 300 or receive information from the server 300.

(4) Main Functions of Server The server 300 according to the present disclosure means a device that stores and manages data within the issue management system.

Specifically, the server 300 may store information related to work and/or information related to an issue, which are received from the worker terminal 100. The server 300 may transmit the information stored in the server 300 to the worker terminal 100.

In addition, the server 300 may store the information related to work and/or the information related to the issue received from the manager terminal 200. The server 300 may transmit the information stored in the server 300 to the manager terminal 200.

Meanwhile, the server 300 may change the stored data, add settings to the data, or reclassify the data according to a request from the manager terminal 200.

According to one exemplary embodiment, the server 300 may receive and store issue occurrence information generated from the worker terminal 100. In this case, the issue occurrence information may be classified as an unconfirmed issue and stored in the server 300.

According to one exemplary embodiment, the server 300 may transmit the stored issue occurrence information to the manager terminal 200.

According to one exemplary embodiment, when the server 300 obtains a registration determination for the unconfirmed issue from the manager terminal 200, the server 300 may reclassify, as a registered issue, the issue occurrence information classified and stored as the unconfirmed issue.

According to one exemplary embodiment, when the server 300 obtains a resolution determination for the registered issue from the manager terminal 200, the server 300 may reclassify, as a resolved issue, the issue occurrence information that is classified and stored as the registered issue.

According to one exemplary embodiment, when the server 300 obtains a deletion determination for the issue from the manager terminal 200, the server 300 may delete the stored issue occurrence information.

According to one exemplary embodiment, the server 300 may receive and store issue occurrence information generated from the manager terminal 100. In this case, the issue occurrence information may be classified as a registered issue and stored in the server 300. Details will be described later.

According to one exemplary embodiment, the server 300 may receive a reminder settings request from the manager terminal 100 and set a reminder for issue occurrence information.

According to one exemplary embodiment, the server 300 may receive an additional message from the manager terminal 100 and store the additional message in issue occurrence information.

The specific details regarding the operation of the server 300 will be described later.

### (5) Additional Exemplary Embodiment of Issue Management System

Meanwhile, in FIG. 2, the issue management system is illustrated as including one worker terminal 100 and one manager terminal 200, but the number of worker terminals 100 and the number of manager terminals 200 are not limited to the above-described example.

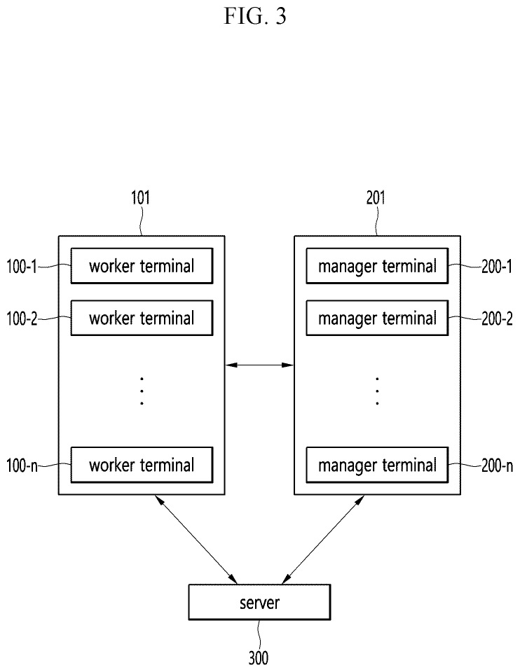

FIG. 3 is a view illustrating an issue management system according to one exemplary embodiment.

Referring to FIG. 3, the issue management system according to one exemplary embodiment may include a plurality of worker terminals 100-1, 100-2, . . . , and 100-n, a plurality of manager terminals 200-1, 200-2, . . . , and 200-n, and a server 300.

Referring to FIG. 3, the plurality of worker terminals 100-1, 100-2, . . . , and 100-n according to one exemplary embodiment may belong to one worker terminal group 101. This is not limited to thereto, and there may be a plurality of worker terminal groups.

Referring to FIG. 3, the plurality of manager terminals 200-1, 200-2, . . . , and 200-n according to one exemplary embodiment may belong to one manager terminal group 201. This is not limited to thereto, and there may be a plurality of manager terminal groups.

### 3. Worker Terminal

Below, a worker terminal according to the present disclosure is described.

The worker terminal according to the present disclosure may mean a terminal used by a worker. The details regarding the worker terminal have been described above in 2. Issue Management System, so any duplicate content will be omitted or briefly described below.

### (1) Components of Worker Terminal

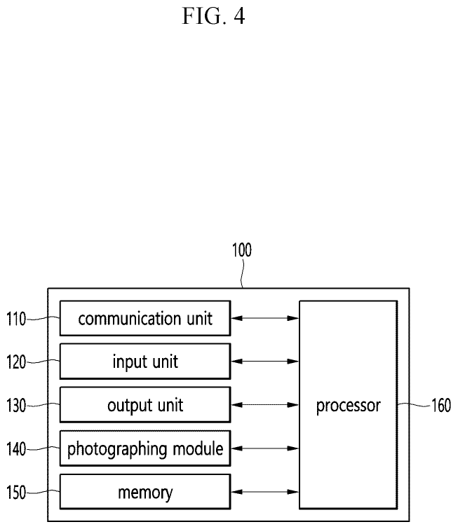

FIG. 4 is a view illustrating a configuration of a worker terminal 100 according to one exemplary embodiment.

Referring to FIG. 4, the worker terminal 100 according to one exemplary embodiment may include a communication unit 110, an input unit 120, an output unit 130, a photographing module 140, a memory 150, and a processor 160. However, this is not limited thereto, and the worker terminal 100 may further include additional components other than these components or may be provided in the form in which some of the components described above are omitted.

The communication unit 110 of the worker terminal 100 may transmit or receive data and/or information to and/or from the outside through wired and/or wireless communication. The worker terminal 100 may perform data communication with the manager terminal 200 and/or server 300 through the communication unit 110.

The input unit 120 of the worker terminal 100 may receive various user operations and transmit the user operations to the processor 160 thereof described later. The input unit 120 may receive the user operations through an interface provided to a user through the output unit 130 thereof described later. The input unit 120 may be implemented as a touchpad, a keypad, a mouse, and/or a microphone, etc.

The output unit 130 of the worker terminal 100 may output results based on the operation of the processor 160 to be described later. The output unit 130 may display various pages, interfaces and/or indicators, etc. to the user. The output unit 130 may be implemented as a display, a touch screen and/or a speaker, etc.

The photographing module 140 of the worker terminal 100 may take photos, videos, and/or images, or recognize QR codes. The worker terminal 100 may obtain the photos, videos, and/or images of the surrounding environment, or recognize the QR codes through the photographing module 140. The photographing module 140 may be implemented as a camera and/or camcorder, etc.

The memory 150 of the worker terminal 100 may store various processing programs, parameters for processing the programs and/or result data of such processing, etc. For example, the memory 150 may store objects including: instructions for the operation of the processor 160 to be described later; photos, videos, and/or images, which are obtained through the photographing module 140; a method for generating issue occurrence information; a method for transmitting the issue occurrence information; a method for displaying the issue occurrence information; and/or a method for displaying an issue input page. The memory 150 may be implemented as a non-volatile semiconductor memory, a hard disk, a flash memory, a random-access memory (RAM), a read-only memory (ROM), an electrically erasable programmable read-only memory (EEPROM), other types of tangible non-volatile recording media, or the like The processor 160 of the worker terminal 100 may perform operations according to the instructions and/or methods stored in the memory 150. In the following, unless otherwise stated, the operation of the worker terminal may be interpreted as being performed by the processor 160 of the worker terminal or being performed under the control of the processor 160. The processor 160 may be implemented as a central processing unit (CPU), a graphics processing unit (GPU), a digital signal processor (DSP), a state machine, an application-specific integrated circuit (ASIC), a radio-frequency integrated circuit (RFIC), a combination thereof, etc.

Hereinafter, unless otherwise specified, the operation of the worker terminal 100 may be understood as being performed by the processor 160 thereof.

### (2) Registering Work Details

The worker terminal according to the present disclosure may display a worker's work details and register the work details on the server. In this case, the worker terminal may display the worker's work details through the output unit and transmit the work details to the server through the communication unit.

According to one exemplary embodiment, a user of a worker terminal may check a work schedule and/or a work list, and perform work through the worker terminal. The user of the worker terminal may register the work details he or she has performed on the server through the worker terminal.

According to one exemplary embodiment, the user of the worker terminal may perform work after recognizing a QR code arranged near a work zone through the worker terminal. For a specific example, the user of the worker terminal may register the start and/or end of work or register a work location by scanning the QR code arranged near the work zone.

### (3) Generating Issue Occurrence Information

A worker terminal according to the present disclosure may generate information regarding issues within a farming area.

Specifically, the worker terminal may generate issue occurrence information according to a user's input. More specifically, the worker terminal may provide the user with an issue input page, and may generate the issue occurrence information on the basis of input information when the user enters the information related to an issue through an interface included in the issue input page. In this case, the worker terminal may display the issue input page through the output unit and obtain the user input through the input unit, thereby generating the issue occurrence information.

Issue occurrence information according to the present disclosure may include various kinds of information for identifying and describing specific issues that have occurred in a farming area.

For example, the issue occurrence information may at least include: a type of issue, an occurrence location of an issue, a photo related to the issue, a description related to the issue, an urgency status of the issue, an occurrence date of the issue, a generation date of the issue occurrence information, and/or a name of a registrant who has registered the issue occurrence information.

According to a user's input, a worker terminal according to one exemplary embodiment may generate issue occurrence information by obtaining the type of issue, an occurrence location of an issue, a photo related to the issue, a description related to the issue, an urgency status of the issue, the occurrence date of the issue, a generation date, and/or a name of a registrant.

Meanwhile, a worker terminal according to one exemplary embodiment may determine some kinds of issue occurrence information on the basis of information stored in the worker terminal. In this case, some kinds of the issue occurrence information may be determined and/or generated without a user's input.

For example, when a worker obtains work location information through a QR code in the process of performing given work, and information about an issue is input by a worker terminal, the worker terminal may determine the work location information obtained through the QR code as an occurrence location of the issue. As another example, the worker terminal may determine a name of a registrant on the basis of information on a user logged into the worker terminal. As a yet another example, the worker terminal may determine a generation date on the basis of date information that is set on the work terminal. The information determined by the worker terminal is not limited to the examples described above, and some kinds of the issue occurrence information may be determined on the basis of information preset in the worker terminal in relation to the issue.

### (4) Transmitting Issue Occurrence Information

The worker terminal according to the present disclosure may transmit the generated issue occurrence information to the server and/or the manager terminal. In this case, the worker terminal may transmit the issue occurrence information to the server and/or manager terminal through the communication unit.

Specifically, the user may transmit the issue occurrence information to the server and/or manager terminal through the worker terminal. In this way, the worker may report details on an issue within a farming area to the manager or store the details on the issue on the server.

### (5) Displaying Issue Occurrence Information

According to the present disclosure, a worker terminal may display issue occurrence information. In this case, the worker terminal may display the issue occurrence information through an output unit.

Specifically, the worker terminal may receive the issue occurrence information from the server and display a page reflecting the received issue occurrence information. More specifically, the worker terminal may generate the page displaying an issue item indicating the issue occurrence information received from the server and provide the page to a user. In this case, the issue occurrence information received from the server may be the issue occurrence information registered by the workers and/or managers who discover the issue within a farming area.

According to one exemplary embodiment, the worker terminal may only display the issue occurrence information that is generated on the worker terminal and transmitted to the server. That is, the issue management system may be implemented so that a worker may check the issue occurrence information. However, the issue management system may also be implemented so that the worker is not allowed to check issue occurrence information for the entire a farming area but allowed to check only issue occurrence information that he or she has input. This is not limited to thereto, and a worker terminal may be implemented to display the issue occurrence information for the entire a farming area, or the worker terminal may also be implemented so that issue occurrence information is not allowed to be displayed thereon.

The issue management system according to the present disclosure may classify issue occurrence information obtained from a worker terminal as an unconfirmed issue, and store the issue occurrence information until an issue registration determination or an issue deletion determination is obtained from a manager terminal. Accordingly, the worker terminal may separately display the issue occurrence information classified as the unconfirmed issue.

The issue management system according to the present disclosure may classify, as a registered issue, not only issue occurrence information of which the issue registration determination is obtained from a manager terminal with respect to the issue occurrence information obtained from a worker terminal, but also issue occurrence information obtained from the manager terminal, and may store the classified issue occurrence information. Accordingly, the worker terminal may separately display the issue occurrence information classified as the registered issue.

### (6) Issue Input Page

According to one exemplary embodiment, a user's input for generating issue occurrence information may be obtained through an issue input page provided on a worker terminal.

The issue input page according to one exemplary embodiment may include at least one issue input interface for inputting the issue occurrence information.

The issue input interface according to one exemplary embodiment may include an occurrence location selection interface, a type selection interface, a photo input interface, an urgency selection interface, and/or a description input interface.

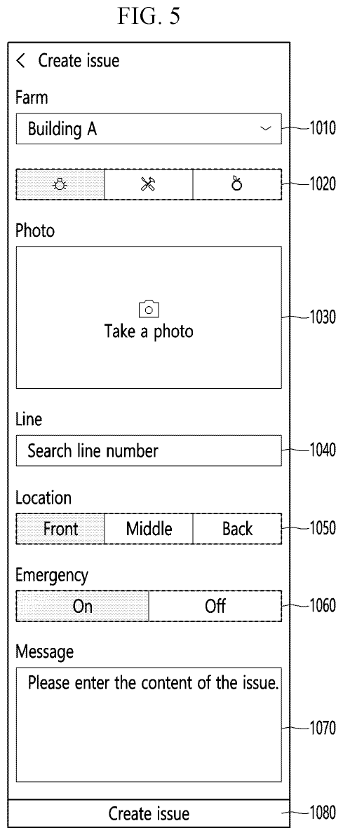

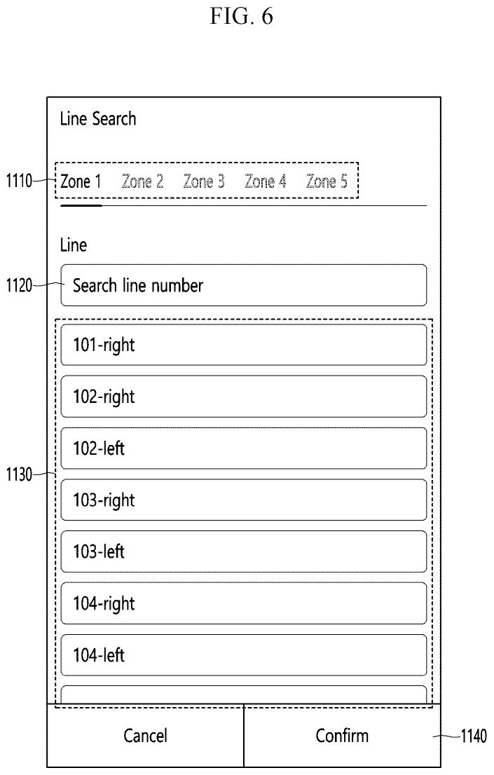

The details of each interface are described with reference to FIGS. 5 and 6.

FIG. 5 is a view illustrating an issue input page according to one exemplary embodiment.

According to the exemplary embodiment, the occurrence location selection interface may be provided to display a preset list of locations so that one of the locations is selected.

Specifically, referring to FIG. 5, the occurrence location selection interface according to one exemplary embodiment may at least include a zone selection interface 1010, a line selection interface 1040, and a line-based location selection interface 1050.

The zone selection interface 1010 according to one exemplary embodiment may be provided to display a preset list of zones and/or zone tabs so that one of them is selected. For example, the list of zones and/or zone tabs may correspond to zones that classify a farming area into Building A, Building B, Building C, etc. (note that “dong” is a Korean unit of building). For another example, the list of zones and/or zone tabs may correspond to zones that classify space within the farming area into Zone 1, Zone 2, Zone 3, Zone 4, etc. The classification of zones and the number of classified zones are not limited to the examples described above, and may be set in various ways depending on the condition and/or current status of the farming area.

The line selection interface 1040 according to one exemplary embodiment may be provided to display a preset list of lines so that one of the lines is selected. Specifically, the line selection interface 1040 may be provided to display the preset list of lines existing within a zone selected through the zone selection interface 1010 so that one of the lines is selected.

FIG. 6 a view illustrating an issue input page according to one exemplary embodiment. Specifically, the issue input page in FIG. 6 may be displayed when the line selection interface 1040 in FIG. 5 is selected.

Referring to FIG. 6, the issue input page according to one exemplary embodiment may be provided with the zone selection interface 1110 and/or the line selection interface 1120.

The zone selection interface 1110 according to one exemplary embodiment may be provided to display preset zone tabs so that one of the zone tabs is selected. For example, referring to FIG. 6, the zone selection interface 1110 may be provided to select one of Zone 1, Zone 2, Zone 3, Zone 4, and Zone 5, and the selected zone may be displayed with a character written in a dark font color and/or bold font.

The line selection interface 1120 according to one exemplary embodiment may be provided to display a preset list of lines 1130 so that one of the lines is selected. For example, referring to FIG. 6, the line selection interface 1120 may be provided to display the list of lines 1130 including 101-right, 102-right, 102-left, 103-right, and 103-left, etc., so that when one of the lines is selected, the selected line is displayed on the line selection interface 1120.

A confirmation interface 1140 may be provided on an issue input page according to one exemplary embodiment. When a user enters a confirmation determination through the confirmation interface 1140, a zone and/or a line respectively selected through the zone selection interface 1110 and/or line selection interface 1120 are determined as an occurrence location of an issue and the worker terminal may display the issue input page in FIG. 5.

Referring back to FIG. 5, the line-based location selection interface 1050 according to one exemplary embodiment may be provided to display preset approximate location tabs so that one of the approximate location tabs is selected. In this case, an approximate location tab may be a tab that means a location on a line. More specifically, the approximate location tabs may include a Front tab, a Middle tab, and a Back tab.

Meanwhile, the occurrence location selection interface according to one exemplary embodiment may be deactivated when there is location information corresponding to a QR code obtained through a worker terminal. In this case, information about an occurrence location of an issue may be determined on the basis of the location information corresponding to the QR code.

On the other hand, the occurrence location selection interface according to one exemplary embodiment may be deactivated when there is location information corresponding to worker information on a worker logged into a worker terminal. In this case, information about an occurrence location of an issue may be determined on the basis of the location information corresponding to the worker information.

Referring to FIG. 5, the type selection interface 1020 according to one exemplary embodiment may be provided to display preset issue type tabs so that one of the issue type tabs is selected. Specifically, the type selection interface 1020 according to one exemplary embodiment may be provided to display a pest and disease tab and a facility failure tab so that one of the tabs is selected. The issue type tabs are not limited to the examples described above, and may be set in various ways depending on conditions of a farming area, types of the farming area, types of crops, types of facilities, weather in a zone where the farming area is located, characteristics of the zone where the farming area is located, and/or surrounding environments of the zone where the farming area is located.

Referring to FIG. 5, the photo input interface 1030 according to one exemplary embodiment may be provided to input photos, which are obtained by using a worker terminal. Specifically, the photo input interface 1030 according to one exemplary embodiment may be provided to input a photo, a video, and/or an image, which are obtained through a photographing module of the worker terminal.

Referring to FIG. 5, the urgency selection interface 1060 according to one exemplary embodiment may be provided to display preset urgency setting tabs so that one of the urgency setting tabs is selected. Specifically, the urgency selection interface 1060 according to one exemplary embodiment may be provided to display an On tab and an Off tab so that one of the tabs is selected.

Referring to FIG. 5, the description input interface 1070 according to one exemplary embodiment may be provided to allow a message to be input according to a user's input. Specifically, the description input interface 1070 according to one exemplary embodiment may be provided to allow the message to be input through the input unit of a worker terminal.

Referring to FIG. 5, the issue generation interface 1080 may be provided on an issue input page according to one exemplary embodiment. When a user enters an issue generation determination through the issue generation interface 1080, the worker terminal may generate issue occurrence information according to information selected through and/or input through the interfaces of the issue input page.

### 4. Manager Terminal

Below, a manager terminal according to the present disclosure is described.

The manager terminal according to the present disclosure may mean a terminal used by a manager. The details regarding the manager terminal have been described above in 2. Issue Management System, so any duplicate content will be omitted or briefly described below.

### (1) Components of Manager Terminal

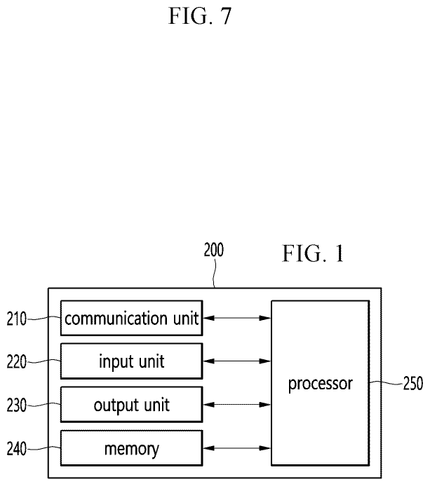

FIG. 7 is a view illustrating a configuration of a manager terminal 200 according to one exemplary embodiment.

Referring to FIG. 7, the manager terminal 200 according to one exemplary embodiment may include a communication unit 210, an input unit 220, an output unit 230, a memory 240, and a processor 250. However, this is not limited thereto, and the manager terminal 200 may include additional components other than these components or may be provided in the form in which some of the components described above are omitted.

The communication unit 210 of the manager terminal 200 may transmit or receive data and/or information to and/or from the outside through wired and/or wireless communication. The manager terminal 200 may perform data communication with the worker terminal 100 and/or server 300 through the communication unit 110.

The input unit 220 of the manager terminal 200 may receive various user operations and transmit the user operations to the processor 250 described later. The input unit 220 may receive the user operations through an interface provided to a user through the output unit 230 described later. The input unit 220 may be implemented as a touchpad, a keypad, a mouse, and/or a microphone, etc.

The output unit 230 of the manager terminal 200 may output results based on the operation of the processor 250 to be described later. The output unit 230 may display various pages, interfaces and/or indicators, etc. to a user. The output unit 230 may be implemented as a display, a touch screen and/or a speaker, etc.

The memory 240 of the manager terminal 200 may store various processing programs, parameters for processing the programs and/or result data of such processing, etc. For example, the memory 240 may store not only instructions for the operation of the processor 250 to be described later, but also methods including: a method for generating issue occurrence information; a method for transmitting the issue occurrence information; a method for displaying the issue occurrence information; a method for managing the issue occurrence information; a method for transmitting the issue management details; a method for displaying an issue input page; a method for displaying an issue status page; and/or a method for displaying an issue detail page. The memory 240 may be implemented as a nonvolatile semiconductor memory, a hard disk, a flash memory, RAM, ROM, EEPROM or other types of nonvolatile recording media, etc.

The processor 250 of the manager terminal 200 may operate according to the instructions and/or the methods stored in the memory 240. In the following, unless otherwise stated, the operation of the manager terminal may be interpreted as being performed by the processor 250 of the manager terminal or being performed under the control of the processor 250 thereof. The processor 250 may be implemented as a central processing unit (CPU), a graphics processing unit (GPU), a digital signal processing unit (DSP), a state machine, an application-specific integrated circuit (ASIC), a radio frequency integrated circuit (RFIC), a combination thereof, etc.

Hereinafter, unless otherwise specified, the operation of the manager terminal 200 may be understood as being performed by the processor 250 thereof.

### (2) Work Management

A manager terminal according to the present disclosure may manage details related to work in a farming area. In this case, the manager terminal may display information related to the work within the farming area through an output unit thereof.

According to one exemplary embodiment, the manager terminal may display work state and/or work progress based on work details registered by a worker on the server.

According to one exemplary embodiment, a user of the manager terminal may check details related to work within the farming area through the manager terminal and manage the work within the farming area. For example, through the manager terminal, the user of the manager terminal may set and/or register a work schedule, set and/or register a zone where the work is to be performed, set and/or register a worker to perform work, or set and/or register work details to be performed by the worker.

### (3) Generating Issue Occurrence Information

A manager terminal according to the present disclosure may generate details regarding an issue within a farming area.

Specifically, the manager terminal may generate issue occurrence information according to a user's input. More specifically, the manager terminal may provide the user with an issue input page, and may generate the issue occurrence information on the basis of input information when the user enters information related to the issue through an interface included in the issue input page. In this case, the manager terminal may display the issue input page through an output unit thereof and obtain the user's input through an input unit thereof, thereby generating the issue occurrence information.

The specific details related to the issue occurrence information generation and issue input page according to one exemplary embodiment have been described above in 3. Worker Terminal, so a duplicate description will be omitted.

Meanwhile, issue occurrence information generated from a manager terminal may be simpler than issue occurrence information generated from a worker terminal. For example, since a manager's confirmation is not required for the issue occurrence information generated from the manager terminal, the issue occurrence information generated on the manager terminal may not include a photo related to an issue.

### (4) Transmitting Issue Occurrence Information

A manager terminal according to the present disclosure may transmit generated issue occurrence information to the server and/or another manager terminal. In this case, the manager terminal may transmit the issue occurrence information to the server and/or another manager terminal through a communication unit thereof.

Specifically, a user may transmit the issue occurrence information to the server and/or another manager terminal through the manager terminal. In this way, a manager may register information about an issue within a farming area on the server and share the information about the issue with another manager.

### (5) Displaying Issue Occurrence Information

A manager terminal according to the present disclosure may display issue occurrence information. In this case, the manager terminal may display the issue occurrence information through an output unit thereof.

According to one exemplary embodiment, the manager terminal may request the issue occurrence information from the server in order to display the issue occurrence information. Specifically, the manager terminal may transmit a trigger for requesting the issue occurrence information to the server.

For example, when starting an operation, the manager terminal may transmit a trigger to the server. As another example, the manager terminal may transmit a trigger along with data when the data is transmitted to the server. As a yet another example, the manager terminal may transmit a trigger to the server at preset time intervals. As a still another example, the manager terminal may transmit a trigger to the server according to a user's update request. In this case, the user may input the update request through an update interface displayed on the manager terminal.

The server may provide one or more pieces of issue occurrence information stored on the server to the manager terminal in response to the trigger.

According to one exemplary embodiment, the manager terminal may display an issue occurrence status page reflecting issue occurrence information. Specifically, the manager terminal may generate the issue occurrence status page displaying an issue item indicating the issue occurrence information received from the server and provide this page to the user. In this case, the issue occurrence information received from the server may be issue occurrence information registered by workers and/or managers who discover issues within a farming area.

According to one exemplary embodiment, the manager terminal may display the issue occurrence status page that allows easy confirmation of the overall issue status of the farming area. For example, the manager terminal may display, on the issue occurrence status page, all issue items in the farming area, only issue items for a specific period, only issue items in a specific zone, only issue items classified as a specific type, or only the number of issues. The specific details regarding the issue occurrence status page are described below.

According to one exemplary embodiment, the manager terminal may display detailed content about issue occurrence information on an issue detail page. Specifically, when a user enters a selection for a specific issue item, the manager terminal may display an issue detail page including issue occurrence information for the selected issue item. The specific details regarding the issue detail page are described below.

### (6) Managing Issue Occurrence Information

A manager terminal according to the present disclosure may manage issue occurrence information. In this case, the manager terminal may display the issue occurrence information through an output unit thereof and obtain a user's input through an input unit thereof, thereby managing the issue occurrence information.

According to one exemplary embodiment, the manager terminal may display an issue detail page for the issue occurrence information and obtain input for managing the issue occurrence information from the user through the issue detail page.

According to one exemplary embodiment, the manager terminal may change information included in issue occurrence information. For example, according to a user's input, the manager terminal may change a type of issue, an occurrence location of an issue, a photo related to the issue, a description related to the issue, an urgency status of the issue, and/or an occurrence date of the issue.

According to one exemplary embodiment, the manager terminal may classify issue occurrence information. For example, the manager terminal may classify, as a registered issue, the issue occurrence information classified as an unconfirmed issue according to a user's input. In addition, the manager terminal may classify the issue occurrence information classified as the registered issue into a resolved issue according to a user's input. In addition, the manager terminal may delete issue occurrence information classified as an unconfirmed issue according to a user's input. In addition, the manager terminal may delete the issue occurrence information classified as the registered issue according to a user's input.

According to one exemplary embodiment, the manager terminal may set a reminder for issue occurrence information. For example, the manager terminal may obtain reminder date information for issue occurrence information according to a user's input, and set a reminder for the issue occurrence information according to the obtained reminder date information.

According to one exemplary embodiment, the manager terminal may generate an alarm when there is issue occurrence information having a preset reminder including reminder date information corresponding to the current date in the issue occurrence information. In this case, the current date may be determined on the basis of date information preset on the manager terminal.

According to one exemplary embodiment, the manager terminal may store an additional message in issue occurrence information. For example, the manager terminal may obtain the additional message about the issue occurrence information according to a user's input and store the obtained additional message in the issue occurrence information. As another example, the manager terminal may store an additional message according to the reclassification in the issue occurrence information when the issue occurrence information is reclassified. Specifically, when the issue occurrence information is reclassified as a registered issue, the manager terminal may store, in the issue occurrence information, an additional message indicating that the issue occurrence information is classified as the registered issue. When the issue occurrence information is reclassified as a resolved issue, the manager terminal may store, in the issue occurrence information, an additional message indicating that the issue occurrence information is classified as the resolved issue. When the issue occurrence information is deleted, the manager terminal may store, in the issue occurrence information, an additional message indicating that the issue occurrence information has been deleted.

According to the present disclosure, communication between managers regarding an issue may be made possible by storing an additional message regarding issue occurrence information in the issue occurrence information. For example, by storing the additional message in the issue occurrence information, a manager may share the processing status of the issue with other managers and/or workers, or may record additional details about the issue. As another example, the manager may determine and announce a manager in charge of the issue in a way of storing an additional message in the issue occurrence information. As a yet another example, the manager may track the history of the issue on the basis of the additional messages stored in the issue occurrence information.

### (7) Transmitting Details of Issue Management

A manager terminal according to the present disclosure may transmit setting information and/or change details regarding issue occurrence information to the server. In this case, the manager terminal may transmit the setting information and/or change details regarding the issue occurrence information to the server through the communication unit thereof.

According to one exemplary embodiment, the manager terminal may transmit the change details for information included in the issue occurrence information to the server, thereby causing the server to change the information included in the issue occurrence information. For example, according to a user's input, the manager terminal may transmit, to the server, the change details regarding a type of issue, an occurrence location of an issue, a photo related to the issue, a description related to the issue, an urgency status of the issue, and/or an occurrence date of the issue, which are included in the issue occurrence information. The server may change the information included in the issue occurrence information on the basis of the received details.

According to one exemplary embodiment, the manager terminal may transmit a classification determination on issue occurrence information to the server, thereby causing the server to classify the issue occurrence information. For example, the manager terminal may obtain an issue registration determination for issue occurrence information classified as an unconfirmed issue according to a user's input and transmit the issue registration determination to the server, and the server may classify the issue occurrence information into a registered issue on the basis of the received issue registration determination. In addition, the manager terminal may obtain an issue resolution determination for the issue occurrence information classified as the registered issue according to a user's input, and transmit the issue resolution determination to the server, and the server may classify the issue occurrence information into the resolved issue on the basis of the received issue resolution determination. In addition, the manager terminal may obtain an issue deletion determination for issue occurrence information classified as the unconfirmed issue according to a user's input and transmit the issue deletion determination to the server, and the server may delete the issue occurrence information on the basis of the received issue deletion determination. In addition, the manager terminal may obtain an issue deletion determination for the issue occurrence information classified as the registered issue according to a user's input and transmit the issue deletion determination to the server, and the server may delete the issue occurrence information on the basis of the received issue deletion determination.

According to one exemplary embodiment, the manager terminal may transmit reminder date information for issue occurrence information to the server, thereby causing the server to set a reminder for the issue occurrence information. For example, the manager terminal may obtain the reminder date information for the issue occurrence information according to a user's input and transmit the reminder date information to the server, and the server may set a reminder for the issue occurrence information according to the received reminder date information.

According to one exemplary embodiment, the manager terminal may transmit an additional message regarding issue occurrence information to the server, thereby causing the server to store the additional message regarding the issue occurrence information. For example, the manager terminal may obtain the additional message regarding the issue occurrence information according to a user's input and transmit the additional message to the server, and the server may store the received additional message in the issue occurrence information. As another example, the manager terminal may obtain an issue registration determination for the issue occurrence information and transmit the issue registration determination to the server, and the server may store, in the issue occurrence information, the additional message indicating that the issue occurrence information is classified as a registered issue. The manager terminal may obtain an issue resolution determination for the issue occurrence information and transmit the issue resolution determination to the server, and the server may store, in the issue occurrence information, an additional message indicating that the issue occurrence information is classified as a resolved issue. The manager terminal may obtain an issue deletion determination for the issue occurrence information and transmit the issue deletion determination to the server, and the server may store, in the issue occurrence information, an additional message indicating that the issue occurrence information has been deleted.

### (8) Issue Status Page

### 1) Issue Item

According to one exemplary embodiment, an issue status page may display an issue item indicating issue occurrence information. In this case, the issue item may mean a form displayed so that a user may easily recognize the issue occurrence information.

An issue item according to one exemplary embodiment may mean that at least one kind of information that may represent an issue is selected and displayed from information included in issue occurrence information. For example, the issue item may mean indicating an occurrence location included in the issue occurrence information. As another example, an issue item may mean indicating a type of issue included in the issue occurrence information. As a yet another example, an issue item may mean that an issue generation date is included in the issue occurrence information. As a still another example, an issue item may mean displaying a photo related to an issue included in the issue occurrence information. This is not limited thereto, and the issue item may mean a combination of the kinds of information included in the issue occurrence information.

According to one exemplary embodiment, an issue status page may display issue items for all kinds of issue occurrence information within a farming area.

The issue status page according to one exemplary embodiment may display an issue item regarding issue occurrence information generated during a specific period.

In an issue status page according to one exemplary embodiment, issue items regarding issue occurrence information occurring in a specific zone may be classified and displayed. For example, an issue item indicating issue occurrence information generated in Zone 1, an issue item indicating issue occurrence information generated in Zone 2, an issue item indicating issue occurrence information generated in Zone 3, and/or an issue item indicating issue occurrence information generated in Zone 4 may be classified and displayed. The criteria for classifying locations where issues have occurred are not limited to the examples described above.

In an issue status page according to one exemplary embodiment, issue items for issue occurrence information may be classified and displayed according to the type of issue included in the issue occurrence information. For example, an issue item indicating issue occurrence information regarding pests and diseases and/or an issue item indicating issue occurrence information regarding facility failures may be classified and displayed.

In an issue status page according to one exemplary embodiment, issue items for issue occurrence information may be classified and displayed according to the status in which the issue occurrence information is classified. For example, an issue item indicating issue occurrence information classified as an unconfirmed issue, an issue item indicating issue occurrence information classified as a registered issue, and/or an issue item indicating issue occurrence information classified as a resolved issue may be classified and displayed.

### 2) Issue Classification Indicator

According to one exemplary embodiment, an issue status page may display an issue classification indicator that classifies issue occurrence information.

According to one exemplary embodiment, an issue status page may display an issue classification indicator that classifies issue occurrence information according to the type of issue included in the issue occurrence information. In this case, the issue classification indicator may include a pest and disease classification indicator and/or a facility failure classification indicator.

According to one exemplary embodiment, an issue status page may display an issue classification indicator that classifies issue occurrence information according to the status in which the issue occurrence information is classified. In this case, the issue classification indicator may include: an unconfirmed issue classification indicator; a registered issue classification indicator; and/or a resolved issue classification indicator.

According to one exemplary embodiment, an issue status page may display an issue classification indicator that classifies issue occurrence information according to an occurrence location of an issue included in the issue occurrence information. In this case, the issue classification indicator may include: a farming area classification indicator; a zone classification indicator; and/or a line classification indicator.

According to one exemplary embodiment, an issue classification indicator may be provided through an issue classification interface. In this case, an issue status page may display issue occurrence information classified according to an issue classification selected through the issue classification interface.

According to one exemplary embodiment, the issue classification interface may be provided to display a preset list of issue classifications and/or issue classification tabs so that one of them is selected.

### 3) Issue Count Indicator

According to one exemplary embodiment, an issue status page may display an issue count indicator indicating the number of pieces of issue occurrence information.

According to one exemplary embodiment, the issue status page may display the issue count indicator that counts the number of pieces of the issue occurrence information according to the type of issue included in the issue occurrence information. In this case, the issue count indicator may include a pest and disease count indicator and/or a facility failure count indicator.

According to one exemplary embodiment, in an issue status page, there may be displayed an issue count indicator that counts the number of pieces of issue occurrence information according to the status in which the issue occurrence information is classified. In this case, the issue count indicator may include an unconfirmed issue count indicator, a registered issue count indicator, and/or a resolved issue count indicator.

According to one exemplary embodiment, an issue status page may display an issue count indicator that counts the number of pieces of issue occurrence information according to an occurrence location of an issue included in the issue occurrence information. In this case, the issue count indicator may include an issue count indicator for each a farming area, an issue count indicator for each zone, and/or an issue count indicator for each line.

### 4) Heatmap

According to one exemplary embodiment, an issue status page may display a heat map based on the number of pieces of issue occurrence information.

According to one exemplary embodiment, the heat map may mean a map in which colors are displayed differently according to the number of pieces of issue occurrence information generated in a corresponding specific zone at a location corresponding to the specific zone on a map corresponding to the entire zone of a farming area. In this case, the colors may have higher saturation and/or brightness as the number of issues increases. This is not limited thereto, and colors may have lower saturation and/or brightness as the number of issues increases.

According to one exemplary embodiment, the heat map may mean a map in which colors are displayed differently according to the number of pieces of issue occurrence information generated in a corresponding line at a location corresponding to the specific line on a map corresponding to a specific zone within the farming area. In this case, the colors may have higher saturation and/or brightness as the number of issues increases. This is not limited thereto, and colors may have lower saturation and/or brightness as the number of issues increases.

According to one exemplary embodiment, a heat map may be displayed on the Web.

### 5) Urgency Indicator

According to one exemplary embodiment, an issue status page may display an urgency indicator indicating an urgency.

According to one exemplary embodiment, the urgency indicator may be displayed together with an issue item indicating issue occurrence information including the urgency.

According to one exemplary embodiment, the urgency indicator may be displayed together with an issue count indicator in which the number of pieces of issue occurrence information including urgencies is counted.

### 6) Reminder Indicator

According to one exemplary embodiment, an issue status page may display a reminder indicator indicating a reminder.

According to one exemplary embodiment, a reminder indicator may be displayed together with an issue item indicating issue occurrence information for which the reminder is set.

According to one exemplary embodiment, the reminder indicator may be displayed together with an issue count indicator in which the number of pieces of issue occurrence information for which a reminder is set is counted.

According to one exemplary embodiment, the reminder indicator may be displayed in different colors depending on reminder date information. For example, when the reminder date information and the current date are the same, a reminder indicator may be displayed with a color having higher saturation and/or brightness than a case when the reminder date information and the current date are different from each other. This is not limited thereto, and reminder date information may be displayed with a color having lower saturation and/or brightness when the reminder date information and the current date are the same than when they differ from each other.

As another example, a reminder indicator may be displayed with a color having higher saturation and/or brighter as a difference between the reminder date information and the current date information becomes smaller. This is not limited thereto, and the reminder indicator may be displayed with a color having lower saturation and/or brightness as the difference between the reminder date information and the current date information becomes smaller.

### 7) Urgent Issue of Current Date

According to one exemplary embodiment, an issue status page may display the current date's urgent issue separately. In this case, the current date's urgent issue may mean issue occurrence information that includes an urgency and whose generation date is the current date. When the issue occurrence information with the set urgency is generated on a worker terminal, the issue occurrence information generated on the worker terminal is classified as an unconfirmed issue and stored. However, this may cause a manager to miss the timing for responding to the corresponding issue, and even though the manager makes a mistake of urgently visiting the occurrence location of the issue, the loss is not great, so this is to ensure that the issue occurrence information including the urgency generated on the worker terminal is displayed with confidence.

According to one exemplary embodiment, an issue status page may separately display an issue item indicating the current date's urgent issue.

According to one exemplary embodiment, an issue status page may separately display the number of counted urgent issues for the current date.

### 8) Update Interface

According to one exemplary embodiment, an update interface may be provided on an issue status page.

The update interface according to one exemplary embodiment may be provided to perform an update on issue occurrence information. For example, a user may select the update interface and transmit a trigger to a server in order to receive the latest issue occurrence information from the server. As another example, the user may select the update interface in order to transmit changed issue occurrence information from a manager terminal to the server.

According to one exemplary embodiment, an interface linking to an issue input page may be provided on the issue status page.

### 9) Exemplary Embodiment of Issue Status Page

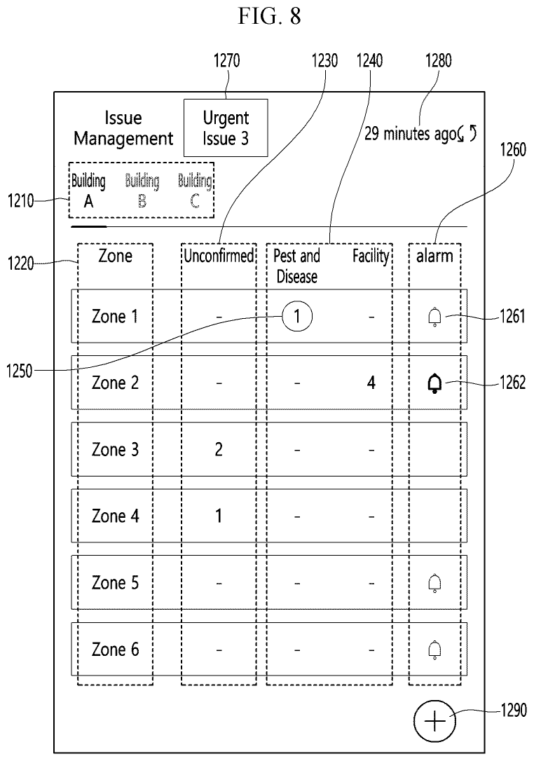

Below, an issue status page is described with reference to FIGS. 8 to 14.

FIG. 8 is a view illustrating an issue status page according to one exemplary embodiment.

Referring to FIG. 8, according to one exemplary embodiment, an issue status page may display a farming area classification interface 1210, a zone classification indicator 1220, an unconfirmed issue count indicator 1230, a pest, disease, and facility failure count indicator 1240, an urgency indicator 1250, a reminder indicator 1260, a current date's urgent issue interface 1270 linking to the issue status page displaying the current date's urgent issue, an update interface 1280, and an issue generation interface 1290 linking to the issue input page.

Referring to FIG. 8, according to one exemplary embodiment, the farming area classification interface 1210 may be provided to display preset a farming area tabs so that one of the farming area tabs is selected. For example, the farming area classification interface 1210 may be provided so that one of Building A, Building B, and Building C is selected.

Referring to FIG. 8, according to one exemplary embodiment, the zone classification indicator 1220 may separately display zones within a farming area. For example, the zone classification indicator 1220 may separately display Zone 1, Zone 2, Zone 3, Zone 4, Zone 5, and Zone 6.

Referring to FIG. 8, according to one exemplary embodiment, the unconfirmed issue count indicator 1230 may display the number of counted pieces of issue occurrence information classified as unconfirmed. Specifically, the number of counted pieces of issue occurrence information classified as unconfirmed may be displayed for each zone classified by the zone classification indicator 1220.

Referring to FIG. 8, according to one exemplary embodiment, the pest, disease, and facility failure count indicator 1240 may display the number of counted pieces of issue occurrence information related to pests and diseases and the number of counted pieces of issue occurrence information related to facility failures. Specifically, the number of counted pieces of issue occurrence information related to pests and diseases and the number of counted pieces of issue occurrence information related to facility failures may be displayed for each zone classified by the zone classification indicator 1220.

Referring to FIG. 8, according to one exemplary embodiment, the urgency indicator 1250 may be displayed together on an issue count indicator where the number of pieces of issue occurrence information including urgencies is counted. Specifically, when issue occurrence information including an urgency exists in issue occurrence information related to pests and diseases for each zone classified by the zone classification indicator 1220, an urgency indicator 1250 in a circular form may be displayed on the issue count indicator 1240 regarding pests and diseases per zone. Alternatively, when issue occurrence information including an urgency exists in issue occurrence information related to facility failures for each zone classified by zone classification indicator 1220, an urgency indicator 1250 in the circular form may be displayed on the issue count indicator 1240 regarding facility failures per zone. Alternatively, when issue occurrence information including an urgency exists in issue occurrence information classified as an unconfirmed issue for each zone classified by the zone classification indicator 1220, an urgency indicator 1250 in the circular form may be displayed on the zone-specific unconfirmed issue count indicator 1230.

Referring to FIG. 8, according to one exemplary embodiment, the reminder indicator 1260 may be displayed together beside an issue count indicator where the number of pieces of issue occurrence information for which a reminder is set is counted. Specifically, when issue occurrence information for which a reminder is set exists in issue occurrence information for each zone classified by the zone classification indicator 1220, reminder indicators 1261 and 1262 may be displayed for respective corresponding zones.

According to one exemplary embodiment, FIG. 8 illustrates an issue status page when a reminder is set for at least one kind of issue occurrence information belonging to Zone 1, Zone 2, Zone 5, and Zone 6. Specifically, FIG. 8 illustrates an issue status page in which issue occurrence information whose reminder date information is set to be the same as the current date exists in at least one kind of issue occurrence information belonging to Zone 2 so as to display a dark-colored reminder indicator 1262 and issue occurrence information whose reminder date information is set to be the same as the current date exists in at least one kind of the issue occurrence information belonging to Zone 1, Zone 5, and Zone 6 so as to display a light-colored reminder indicator 1261.

Referring to FIG. 8, the current date's urgent issue interface 1270 may be provided through the issue status page. A manager terminal may display a current date's urgent issue according to a user's input through the current date's urgent issue interface 1270.

Referring to FIG. 8, the update interface 1280 may be provided through the issue status page. The manager terminal may update the issue occurrence information according to a user's input through the update interface 1280.

Referring to FIG. 8, the issue generation interface 1290 may be provided through the issue status page. The manager terminal may display the issue status page according to a user's input through the issue generation interface 1290.

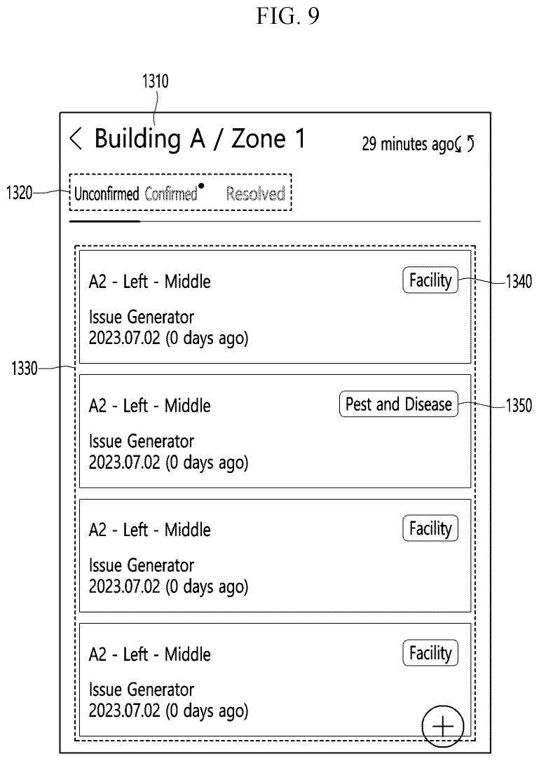

FIG. 9 is a view illustrating an issue status page according to one exemplary embodiment.

Referring to FIG. 9, according to one exemplary embodiment, an issue status page may display a zone classification indicator 1310, an issue classification interface 1320, an issue item 1330 indicating issue occurrence information classified as an unconfirmed issue, a facility failure classification indicator 1340, and a pest and disease classification indicator 1350.

Referring to FIG. 9, according to one exemplary embodiment, the zone classification indicator 1310 may indicate a zone to which issue items appearing on the issue status page belong. For example, the zone classification indicator 1310 may indicate that issue items appearing on the issue status page are issues that have occurred in Zone 1 of Building A.

Referring to FIG. 9, according to one exemplary embodiment, the issue classification interface 1320 may be provided to display preset issue classification tabs so that one of the issue classification tabs is selected. For example, the issue classification interface 1320 may be provided to allow selecting one of an unconfirmed issue, a confirmed and registered issue, and a resolved issue.

Referring to FIG. 9, according to one exemplary embodiment, the issue item 1330 may indicate issue occurrence information classified as an issue status selected through the issue classification interface 1320. For example, the issue item 1330 may indicate the issue occurrence information classified as an unconfirmed issue selected through the issue classification interface 1320. The issue item may refer to a form displayed so that a user can easily recognize the issue occurrence information. Since the specific details have been described above, a duplicate description will be omitted.

Referring to FIG. 9, the facility failure classification indicator 1340 may be displayed in an issue item indicating issue occurrence information regarding a facility failure. Since the facility failure classification indicator has been described above, a duplicate description will be omitted.

Referring to FIG. 9, the pest and disease classification indicator 1350 may be displayed on an issue item indicating issue occurrence information related to pests and diseases. Since the pest and disease classification indicator has been described above, a duplicate description will be omitted.

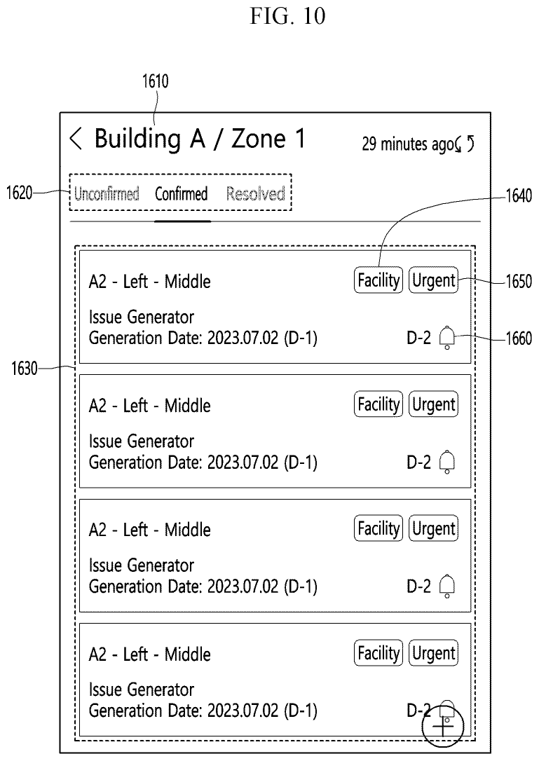

FIG. 10 is a view illustrating an issue status page according to one exemplary embodiment.

Referring to FIG. 10, according to one exemplary embodiment, the issue status page may display a zone classification indicator 1610, an issue classification interface 1620, an issue item 1630 indicating issue occurrence information classified as a confirmed and registered issue, a facility failure classification indicator 1640, an urgency indicator 1650, and a reminder indicator 1660.

According to one exemplary embodiment, the details related to the zone classification indicator 1610, issue classification interface 1620, and facility failure classification indicator 1640 have been described above in FIG. 9, so a duplicate description will be omitted.

In FIG. 10, only the facility failure classification indicator 1640 is displayed, but a pest and disease classification indicator may also be displayed depending on the issue type of issue occurrence information.

Referring to FIG. 10, according to one exemplary embodiment, the issue item 1630 may indicate issue occurrence information classified as issue status selected through the issue classification interface 1620. For example, the issue item 1630 may represent the issue occurrence information classified as a confirmed and registered issue selected through the issue classification interface 1620. The issue item may refer to a form displayed so that a user can easily recognize the issue occurrence information. Since the specific details have been described above, a duplicate description will be omitted.

Referring to FIG. 10, the urgency indicator 1650 may be displayed on an issue item indicating issue occurrence information including an urgency. Since the urgency indicator has been described above, a duplicate description will be omitted.

Referring to FIG. 10, the reminder indicator 1660 may be displayed on an issue item indicating issue occurrence information for which a reminder is set. Specifically, both an icon enabling to identify whether issue occurrence information is set with a reminder or not and the number of days remaining until a reminder date may be displayed as the reminder indicator 1660. In this case, the icon will be displayed in a light color, but when the reminder date is the current date, the icon may be displayed in a dark color.

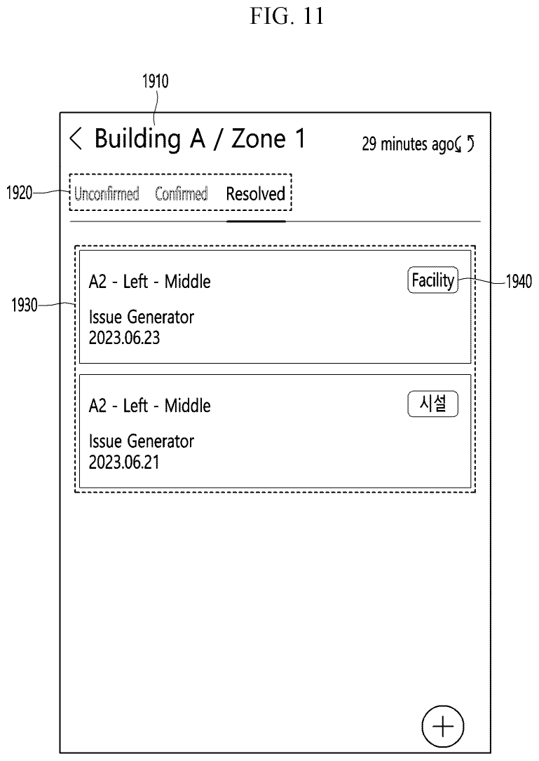

FIG. 11 is a view illustrating an issue status page according to one exemplary embodiment.

Referring to FIG. 11, according to one exemplary embodiment, the issue status page may display a zone classification indicator 1910, an issue classification interface 1920, an issue item 1930 indicating issue occurrence information classified as a resolved issue, and a facility failure classification indicator 1940.

According to one exemplary embodiment, the details related to the zone classification indicator 1910, issue classification interface 1920, and facility failure classification indicator 1940 have been described above in FIG. 9, so a duplicate description will be omitted.

In FIG. 11, only the facility failure classification indicator 1940 is displayed, but a pest and disease classification indicator may also be displayed depending on the issue type of issue occurrence information.

Referring to FIG. 11, according to one exemplary embodiment, an issue item 1930 may indicate issue occurrence information classified as a resolved issue selected through an issue classification interface 1920. The issue item may refer to a form displayed so that a user can easily recognize the issue occurrence information. Since the specific details have been described above, a duplicate description will be omitted.

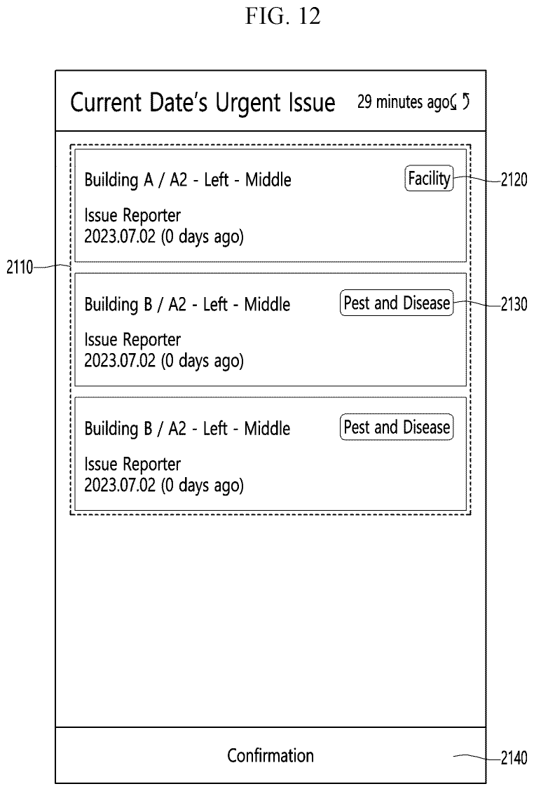

FIG. 12 is a view illustrating an issue status page according to one exemplary embodiment.

Referring to FIG. 12, according to one exemplary embodiment, the issue status page may display an issue item 2110 indicating the current date's urgent issue, a facility failure classification indicator 2120, a pest and disease classification indicator 2130, and a confirmation interface 2140.

According to one exemplary embodiment, the details related to the facility failure classification indicator 2120 and the pest and disease classification indicator 2130 have been described above in FIG. 9, so a duplicate description will be omitted.

Referring to FIG. 12, according to one exemplary embodiment, an issue item 2110 may indicate issue occurrence information determined to be an urgent issue for the current date. The urgent issue for the current date means the issue occurrence information that includes an urgency and whose generation date is the current date. The issue item may refer to a form displayed so that a user can easily recognize the issue occurrence information. Since the specific details have been described above, a duplicate description will be omitted.

According to one exemplary embodiment, the issue status page in FIG. 12 may be displayed according to a user's selection through the current date's urgent issue interface 1270 illustrated in FIG. 8. In this case, the user may select a confirmation interface 2140, so as to return to a page such as that in FIG. 8.

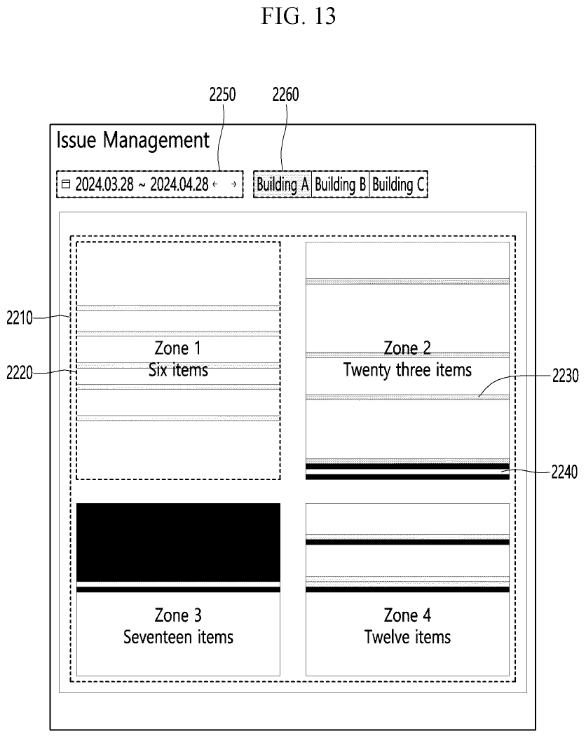

FIG. 13 is a view illustrating an issue status page according to one exemplary embodiment.

Referring to FIG. 13, according to one exemplary embodiment, the issue status page may display a heat map 2210 for the entire a farming area, a heat map 2220 for a specific zone within the farming area, a period selection interface 2250, and a farming area classification interface 2260.

According to one exemplary embodiment, the details related to the farming area classification interface 2260 are described above in FIG. 8, so a duplicate description will be omitted.

Referring to FIG. 13, according to one exemplary embodiment, the heat map 2210 for the entire a farming area may display a heat map for the entire zone included in the farming area selected through the farming area classification interface 2260. For example, when Building A is selected through the farming area classification interface 2260, heat maps for Zone 1, Zone 2, Zone 3, and Zone 4 included in Building A may be displayed as the heat map 2210 for the entire a farming area.

Referring to FIG. 13, according to one exemplary embodiment, the heat map 2220 for a specific zone may display a heat map for the specific zone included in the farming area selected through the farming area classification interface 2260. For example, when Building A is selected through the farming area classification interface 2260, each of a heat map 2220 for Zone 1 included in Building A, a heat map for Zone 2 included in Building A, a heat map for Zone 3 included in Building A, and a heat map for Zone 4 included in Building A may be displayed. Each heat map may refer to a map that displays a different color in a location corresponding to a specific zone depending on the number of pieces of issue occurrence information generated in the corresponding specific zone. Since the details related to the heat map have been described above, a duplicate description will be omitted.

Referring to FIG. 13, the heat map 2220 for a specific zone may display a different color for a corresponding line depending on the number of pieces of issue occurrence information generated on the corresponding line at a location corresponding to the specific line on the map corresponding to the specific zone. For example, when the number of pieces of issue occurrence information generated on the corresponding line is small, the corresponding line may be displayed in a light color 2230, and when the number of pieces of issue occurrence information generated on the corresponding line is large, the corresponding line may be displayed in a dark color 2240. The method of displaying a color of a line depending on the number of pieces of issue occurrence information is not limited to the above-described example.

Referring to FIG. 13, according to one exemplary embodiment, the heat map 2220 for a specific zone may also display the total number of pieces of issue occurrence information generated in the corresponding zone.

Referring to FIG. 13, according to one exemplary embodiment, the period selection interface 2250 may be provided to select a period to which issue occurrence information to be displayed as a heat map belongs. When the period is selected through the period selection interface 2250, the heat map 2220 for a specific zone may be displayed depending on the number of pieces of issue occurrence information belonging to the period selected through the period selection interface 2250.

As illustrated in FIG. 13, the issue status page displays the number of pieces of issue occurrence information as the heat map, so that a user may intuitively and easily recognize in which zone and which location issues have occurred the most.

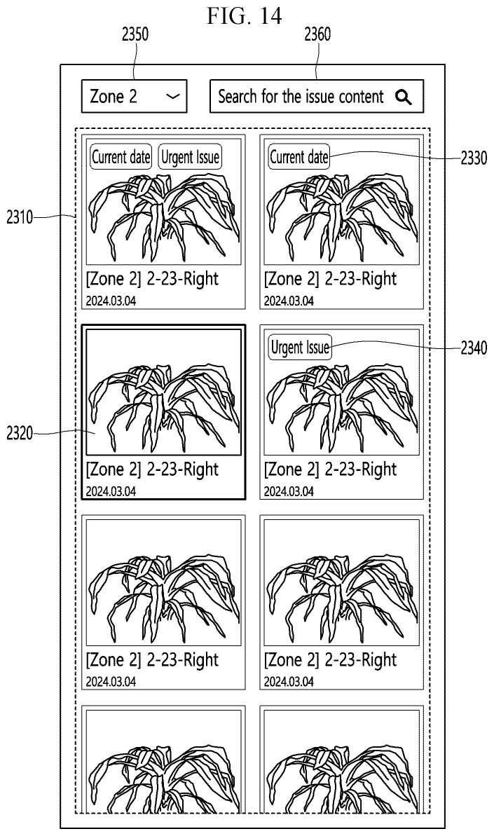

FIG. 14 is a view illustrating an issue status page according to one exemplary embodiment.

Referring to FIG. 14, according to one exemplary embodiment, an issue status page may display an issue item 2310 indicating issue occurrence information generated in a specific zone, an issue item thumbnail 2320 indicating one kind of issue occurrence information, the current date indicator 2330, an urgency indicator 2340, a zone classification interface 2350, and an issue search interface 2360.

According to one exemplary embodiment, the details related to the urgency indicator 2340 and the zone classification interface 2350 are described above, so a duplicate description will be omitted.

Referring to FIG. 14, according to one exemplary embodiment, the issue item 2310 may indicate issue occurrence information generated in a zone selected through the zone classification interface 2350.

Referring to FIG. 14, according to one exemplary embodiment, the issue item 2310 may be displayed in the form of the issue item thumbnail 2320. According to one exemplary embodiment, the issue item thumbnail 2320 means displaying a photo included in issue occurrence information. For example, the issue item thumbnail 2320 may mean a small representation of a representative photo included in the issue occurrence information.

As illustrated in FIG. 14, the issue status page displays the issue occurrence information in the thumbnail form, so that a user may intuitively and easily recognize which issue each issue item is related to.

Referring to FIG. 14, the issue item thumbnail indicating issue occurrence information whose generation date is the current date may display the current date indicator 2330.

Referring to FIG. 14, according to one exemplary embodiment, the issue search interface 2360 may be provided to display an issue search window so that the user may search for details regarding issue occurrence information that the user desires to search for. In this case, in an issue status page, an issue item thumbnail representing the issue occurrence information including details input through the issue search interface 2360 may be classified and displayed.

According to the exemplary embodiment described above, the issue status page may be generated and displayed on the manager terminal on the basis of the issue occurrence information. This is not limited thereto, and according to one exemplary embodiment, an issue status page may be generated on the server on the basis of the issue occurrence information and provided to and displayed on the manager terminal.

### (9) Issue Detail Page

According to one exemplary embodiment, an issue detail page may display information about issue occurrence information.

Specifically, according to one exemplary embodiment, the issue detail page may display indicators including: an issue type indicator according to the type of issue included in issue occurrence information; an occurrence location indicator according to an occurrence location of an issue; an image indicator according to a photo related to the issue; a description indicator according to a description related to the issue; an urgency indicator according to an urgency status of the issue; a reminder indicator according to a reminder setting; and/or a message indicator according to an additional message.

According to one exemplary embodiment, the indicators displayed on the issue detail page may vary depending on the classification of the issue occurrence information. For example, an issue detail page for issue occurrence information classified as an unconfirmed issue may not display a reminder indicator and/or a message indicator.

According to one exemplary embodiment, an issue detail page may display information about an issue item selected according to a user's input. In this case, the issue item may be an issue item displayed on an issue status page. Since the details related to the issue item and issue status page have been described above, a duplicate description will be omitted.

According to one exemplary embodiment, an issue registration interface may be further provided on an issue detail page for issue occurrence information classified as an unconfirmed issue.

According to one exemplary embodiment, the issue occurrence information displayed on the issue detail page may be reclassified as a registered issue through the issue registration interface. Specifically, when obtaining an issue registration determination through the issue registration interface, a manager terminal may reclassify the issue occurrence information into the registered issue. Alternatively, when obtaining the issue registration determination through the issue registration interface, the manager terminal may transmit the issue registration determination to the server, thereby causing the server to reclassify the issue occurrence information into the registered issue.

According to one exemplary embodiment, an issue resolution interface may be further provided on an issue detail page for issue occurrence information classified as a registered issue.

According to one exemplary embodiment, the issue occurrence information displayed on the issue detail page may be reclassified as a resolved issue through the issue resolution interface. Specifically, when obtaining an issue resolution determination through the issue resolution interface, the manager terminal may reclassify the issue occurrence information as the resolved issue. Alternatively, when obtaining the issue resolution determination through the issue resolution interface, the manager terminal may transmit the issue resolution determination to the server, causing the server to reclassify the issue occurrence information as the resolved issue.

According to one exemplary embodiment, an issue detail page may be further provided with an issue deletion interface.

According to one exemplary embodiment, issue occurrence information displayed on an issue detail page may be deleted through the issue deletion interface. Specifically, when obtaining an issue deletion determination through the issue deletion interface, the manager terminal may delete the issue occurrence information. Alternatively, when obtaining the issue deletion determination through the issue deletion interface, the manager terminal may transmit the issue deletion determination to the server, thereby causing the server to delete the issue occurrence information.

According to one exemplary embodiment, an issue detail page may be further provided with a message input interface.

According to one exemplary embodiment, the message input interface may be provided to input a message according to a user's input.

According to one exemplary embodiment, issue occurrence information displayed on an issue detail page may store an additional message input by the user through the message input interface. Specifically, when obtaining an additional message through the message input interface, the manager terminal may store the additional message in issue occurrence information. Alternatively, when obtaining the additional message through the message input interface, the manager terminal may transmit the additional message to the server, causing the server to store the additional message in the issue occurrence information.

According to one exemplary embodiment, an issue detail page may be further provided with an urgency selection interface.

According to one exemplary embodiment, the urgency selection interface may be provided to display preset urgency activation tabs so that one of the urgency activation tabs is selected.

According to one exemplary embodiment, an urgency status may be set into issue occurrence information displayed on an issue detail page through the urgency selection interface. Specifically, when receiving input of urgency activation through the urgency selection interface, the manager terminal may change the urgency status for the issue occurrence information to an urgency. Alternatively, when receiving the input of urgency activation through the urgency selection interface, the manager terminal may transmit urgency activation information to the server, thereby causing the server to change the urgency status for the issue occurrence information to the urgency. Meanwhile, when receiving input of urgency deactivation through the urgency selection interface, the manager terminal may cancel the urgency status of the issue occurrence information. Alternatively, when receiving the input of urgency deactivation through the urgency selection interface, the manager terminal may transmit the urgency deactivation information to the server, thereby causing the server to cancel the urgency status of the issue occurrence information.

According to one exemplary embodiment, an issue detail page may be further provided with a reminder settings interface.

According to one exemplary embodiment, the reminder settings interface may be provided to display preset reminder activation tabs so that one of the reminder activation tabs is selected, and display a date input window so that date information is input according to a user's input.

According to one exemplary embodiment, issue occurrence information displayed on an issue detail page may have a reminder that is set through the reminder settings interface. Specifically, the manager terminal may set the reminder for the issue occurrence information when reminder activation and date information are input through the reminder settings interface. Alternatively, when receiving the reminder activation and date information through the reminder settings interface, the manager terminal may transmit the reminder activation and date information to the server, thereby causing the server to set the reminder for the issue occurrence information.

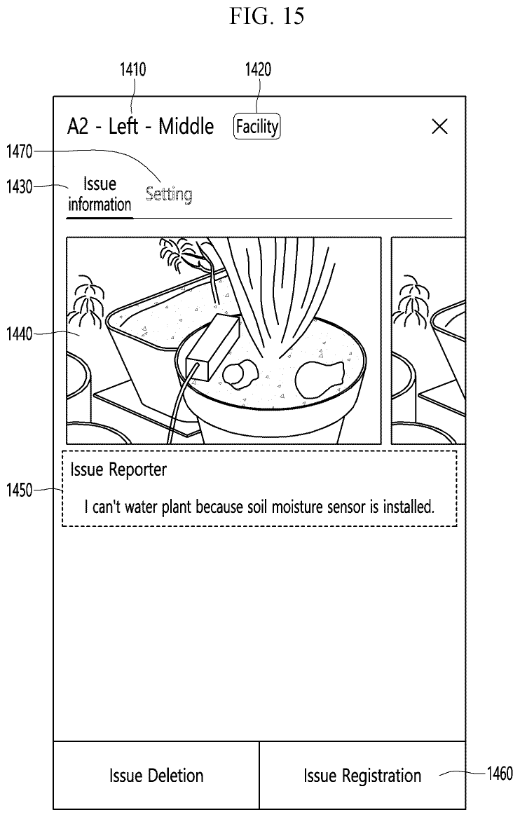

Below, an issue detail page is described with reference to FIGS. 15 to 19.

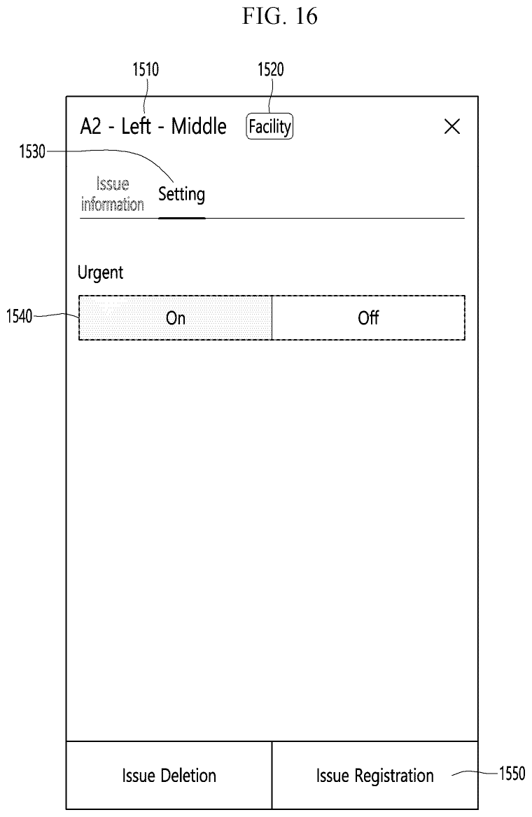

FIGS. 15 and 16 are views each illustrating an issue detail page according to one exemplary embodiment.

The issue detail page according to FIGS. 15 and 16 may be displayed when one of issue items illustrated in FIG. 9 is selected. Specifically, each issue detail page according to FIGS. 15 and 16 may display information on the issue occurrence information classified as an unconfirmed issue.

Referring to FIG. 15, according to one exemplary embodiment, an issue detail page may display an occurrence location indicator 1410, an issue type indicator 1420, an information page interface 1430, an image indicator 1440, a description indicator 1450, an issue registration interface 1460, and a settings page interface 1470.

According to one exemplary embodiment, the occurrence location indicator 1410 may display an occurrence location included in issue occurrence information displayed on an issue detail page. For example, the occurrence location indicator 1410 may display an issue occurrence zone, an issue occurrence line, and a location within a line, which are included in the issue occurrence information.

According to one exemplary embodiment, the issue type indicator 1420 may display the type of issue included in issue occurrence information displayed on the issue detail page. For example, the issue type indicator 1420 may display a pest and disease indicator or a facility failure indicator depending on the type of issue included in the issue occurrence information.

According to one exemplary embodiment, the image indicator 1440 may display a photo related to an issue included in the issue occurrence information displayed on the issue detail page.

According to one exemplary embodiment, the description indicator 1450 may display a description related to the issue included in the issue occurrence information displayed on the issue detail page. In this case, the description indicator 1450 may also display a name of a registrant of the issue occurrence information.

According to one exemplary embodiment, the information page interface 1430 and the settings page interface 1470 may be provided so that a user may select one of the information page interface 1430 and the settings page interface 1470.

According to one exemplary embodiment, when a user input is obtained through the information page interface 1430, the issue detail page may display a page focused on information about the issue occurrence information.

According to one exemplary embodiment, when a user input is obtained through the settings page interface 1470, an issue detail page may display a page focused on changing settings for the issue occurrence information.

According to one exemplary embodiment, the issue registration interface 1460 may be provided for the user to perform selection.

According to one exemplary embodiment, when a user input is obtained through the issue registration interface 1460, the issue occurrence information displayed on the issue detail page may be reclassified as a registered issue. Since the details related to the reclassification of issue occurrence information have been described above, a duplicate description will be omitted.

The issue detail page in FIG. 16 may be displayed when a user input is obtained through the settings page interface 1470 illustrated in FIG. 15.

Referring to FIG. 16, according to one exemplary embodiment, the issue detail page may display an occurrence location indicator 1510, an issue type indicator 1520, a settings page interface 1530, an urgency selection interface 1540, and an issue registration interface 1550.

According to one exemplary embodiment, the details related to the occurrence location indicator 1510, the issue type indicator 1520, the settings page interface 1530, and the issue registration interface 1550 have been described above in FIG. 15, so a duplicate description will be omitted.

Referring to FIG. 16, according to one exemplary embodiment, the urgency selection interface 1540 may be provided to display preset urgency activation tabs so that one of the urgency activation tabs is selected. Since the details related to setting the urgency status have been described above, a duplicate description will be omitted.

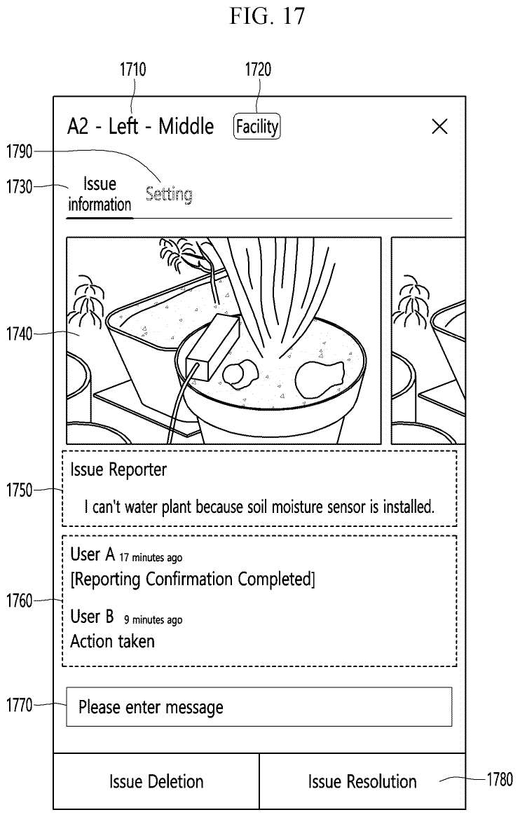

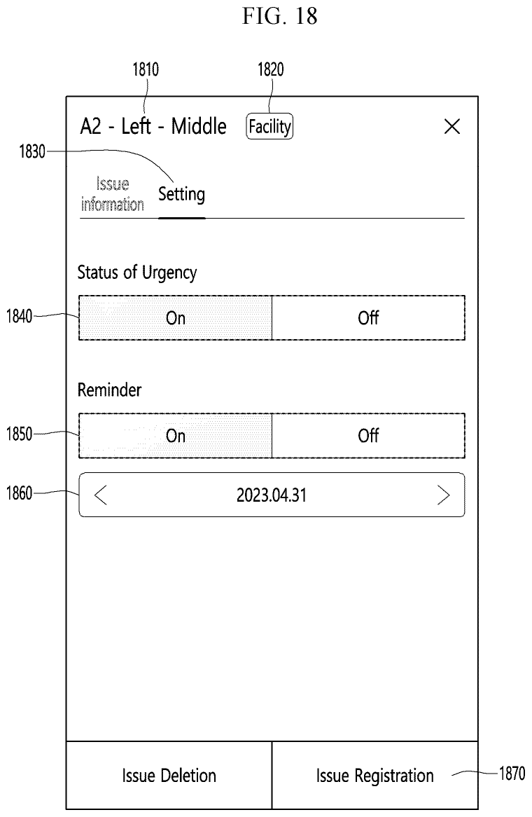

FIGS. 17 and 18 are view each illustrating an issue detail page according to one exemplary embodiment.

The issue detail page according to FIGS. 17 and 18 may be displayed when one of the issue items illustrated in FIG. 10 is selected. Specifically, each issue detail page according to FIGS. 17 and 18 may display information on issue occurrence information classified as a registered issue.

Referring to FIG. 17, according to one exemplary embodiment, the issue detail page may display an occurrence location indicator 1710, an issue type indicator 1720, an information page interface 1730, an image indicator 1740, a description indicator 1750, a message indicator 1760, a message input interface 1770, an issue resolution interface 1780, and a settings page interface 1790.

According to one exemplary embodiment, the details related to the occurrence location indicator 1710, issue type indicator 1720, information page interface 1730, image indicator 1740, description indicator 1750, and settings page interface 1790 have been described above in FIG. 15, so a duplicate description will be omitted.

According to one exemplary embodiment, the message indicator 1760 may display each additional message stored in the issue occurrence information displayed on the issue detail page. The issue detail page in FIG. 17 is about the issue occurrence information classified as the registered issue, so it may be confirmed that the message indicator 1760 displays each additional message indicating that the issue occurrence information has been confirmed and classified as the registered issue. In addition to this, the details related to the additional messages have been described above, so a duplicate description will be omitted.

According to one exemplary embodiment, the message input interface 1770 may be provided so that a message is input according to a user's input. According to one exemplary embodiment, when receiving input of an additional message through the message input interface 1770, the manager terminal and/or server may store the additional message in issue occurrence information. Since the details related to the message input interface have been described above, a duplicate description will be omitted.

According to one exemplary embodiment, the issue resolution interface 1780 may be provided for a user to perform selection.

According to one exemplary embodiment, when a user input is obtained through the issue resolution interface 1780, the issue occurrence information displayed on the issue detail page may be reclassified as a resolved issue. Since the details related to the reclassification of issue occurrence information have been described above, a duplicate description will be omitted.

The issue detail page in FIG. 18 may be displayed when a user input is obtained through the settings page interface 1790 illustrated in FIG. 17.

Referring to FIG. 18, according to one exemplary embodiment, the issue detail page may display an occurrence location indicator 1810, an issue type indicator 1820, a settings page interface 1830, an urgency selection interface 1840, reminder settings interfaces 1850 and 1860, and an issue resolution interface 1870.

According to one exemplary embodiment, the details related to the occurrence location indicator 1810, issue type indicator 1820, and settings page interface 1830 have been described above in FIG. 15, so a duplicate description will be omitted.

According to one exemplary embodiment, the details related to the issue resolution interface 1870 have been described above in FIG. 17, so a duplicate description will be omitted.

According to one exemplary embodiment, the urgency selection interface 1840 may be provided to display preset urgency activation tabs so that one of the urgency activation tabs is selected. Since the details related to the status setting of the urgency status have been described above, a duplicate description will be omitted.

According to one exemplary embodiment, the reminder settings interfaces 1850 and 1860 may include a reminder activation interface 1850 and a reminder date input interface 1860.

According to one exemplary embodiment, the reminder activation interface 1850 may be provided to display preset reminder activation tabs so that one of the reminder activation tabs is selected. According to one exemplary embodiment, the reminder date input interface 1860 may be provided to input date information according to a user's input. Since the details related to the reminder settings have been described above, a duplicate description will be omitted.

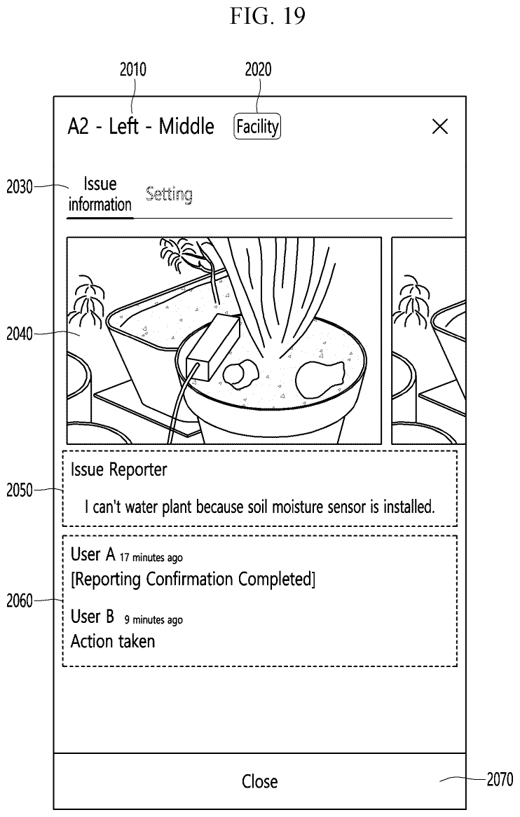

FIG. 19 is a view illustrating an issue detail page according to one exemplary embodiment.

The issue detail page according to FIG. 19 may be displayed when one of the issue items illustrated in FIG. 11 is selected. Specifically, the issue detail page according to FIG. 19 may display information on the issue occurrence information classified as the resolved issue.

Referring to FIG. 19, according to one exemplary embodiment, the issue detail page may display an occurrence location indicator 2010, an issue type indicator 2020, an information page interface 2030, an image indicator 2040, a description indicator 2050, a message indicator 2060, and a page closing interface 2070.

According to one exemplary embodiment, the details related to the occurrence location indicator 2010, issue type indicator 2020, information page interface 2030, and image indicator 2040 have been described above in FIG. 15, so a duplicate description will be omitted.

According to one exemplary embodiment, the message indicator 2060 may display each additional message stored in the issue occurrence information displayed on the issue detail page. Since the details related to the additional messages have been described above, a duplicate description will be omitted.

According to one exemplary embodiment, the page closing interface 2070 may be provided for a user to perform selection.

According to one exemplary embodiment, when a user input is obtained through the page closing interface 2070, the issue detail page may be closed and the previous issue status page before the issue detail page is displayed may be displayed.

According to the exemplary embodiment described above, the issue detail page may be generated and displayed on the manager terminal on the basis of the issue occurrence information. This is not limited thereto, and according to one exemplary embodiment, the issue detail page may be generated on the server on the basis of the issue occurrence information, and provided to and displayed on the manager terminal.

### 5. Server

The following describes a server.

The server according to the present disclosure may mean a device configured to perform data communication with a worker terminal and a manager terminal, and store and/or manage data. The details regarding the server have been described above in 2. Issue Management System, so any duplicate content will be omitted or briefly described below.

### (1) Components of Server

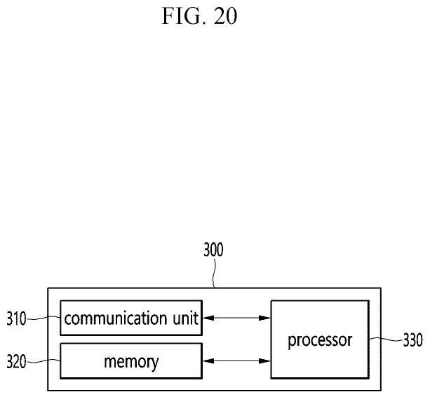

FIG. 20 is a view illustrating a configuration of a server 300 according to one exemplary embodiment.

Referring to FIG. 20, the server 300 according to one exemplary embodiment may include a communication unit 310, a memory 320, and a processor 330. However, this is not limited thereto, and the server 300 may include additional components other than these components or may be provided in the form in which some of the components described above are omitted.

The communication unit 310 of the server 300 may transmit or receive data and/or information to and/or from the outside through wired and/or wireless communication. The server 300 may perform data communication with a worker terminal 100 and/or manager terminal 200 through the communication unit 310.

The memory 320 of the server 300 may store various processing programs, parameters for processing the programs and/or result data of such processing, etc. For example, the memory 320 may store instructions for the operation of the processor 330 to be described later, an issue storage method, and/or an issue management method, etc. The memory 320 may be implemented as a nonvolatile semiconductor memory, a hard disk, a flash memory, RAM, ROM, EEPROM, or other types of nonvolatile recording media.

The processor 330 of the server 300 may operate according to the instructions and/or methods stored in the memory 320. In the following, unless otherwise stated, the operation of the server may be interpreted as being performed by the processor 330 of the server or being performed under the control of the processor 330. The processor 330 may be implemented as a central processing unit (CPU), a graphics processing unit (GPU), a digital signal processing unit (DSP), a state machine, an application-specific integrated circuit (ASIC), a radio frequency integrated circuit (RFIC), a combination thereof, etc.

Hereinafter, unless otherwise specified, the operation of the server 300 may be understood to be performed by the processor 330.

### (2) Storing Issue Occurrence Information

The server according to the present disclosure may store issue occurrence information received from a worker terminal and/or a manager terminal. In this case, the server may receive the issue occurrence information from the worker terminal and/or the manager terminal through the communication unit thereof, and store, through the memory thereof, the received issue occurrence information.

The specific details related to the issue occurrence information have been described above in 3. Worker Terminal, so a duplicate description will be omitted.

### (3) Classifying Issue Occurrence Information

The server according to the present disclosure may classify and store the received issue occurrence information according to preset conditions. Specifically, when registering the issue occurrence information in the issue management system, the server may classify and register the issue occurrence information according to the preset conditions. In this case, the server may classify the issue occurrence information received through the communication unit thereof according to the preset conditions and store the issue occurrence information in the memory thereof.

According to one exemplary embodiment, the server may classify the issue occurrence information received from the worker terminal as an unconfirmed issue and store this classified issue occurrence information. The unconfirmed issue may refer to a state before this issue is registered or deleted after the issue occurrence information has been confirmed by a manager. That is, the unconfirmed issue may mean a temporarily registered issue.

According to one exemplary embodiment, the server may classify the issue occurrence information received from the manager terminal into a registered issue and store this classified issue occurrence information. The issue occurrence information received from the manager terminal may be generated by the manager, so the issue occurrence information may be immediately classified and stored as the registered issue.

### (4) Managing Issue Occurrence Information

The server according to the present disclosure may manage the stored issue occurrence information. In this case, the server may manage the issue occurrence information stored in the memory thereof.

According to one exemplary embodiment, the server may transmit the stored issue occurrence information to a worker terminal and/or a manager terminal.

Specifically, the server may transmit the issue occurrence information to the worker terminal and/or the manager terminal in response to a trigger received from the worker terminal and/or the manager terminal. The specific details related to the trigger have been described above in 4. Manager Terminal, so a duplicate description will be omitted.

According to one exemplary embodiment, the server may reclassify and store the stored issue occurrence information.

Specifically, the server may reclassify the issue occurrence information into a registered issue according to an issue registration determination made on the issue occurrence information received from the manager terminal. In addition, the server may reclassify the issue occurrence information into a resolved issue according to an issue resolution determination made on the issue occurrence information received from the manager terminal. In addition, the server may delete the issue occurrence information according to an issue deletion determination made on the issue occurrence information received from the manager terminal. Since the details related to the reclassification of issue occurrence information have been described above in 4. Manager Terminal, a duplicate description will be omitted.

According to one exemplary embodiment, the server may change some kinds of information of the stored issue occurrence information.

Specifically, the server may change the information included in the issue occurrence information according to setting information and/or change details to the issue occurrence information received from the manager terminal. The details related to the information change of the issue occurrence information have been described above in 4. Manager Terminal, so a duplicate description will be omitted.

The server according to one exemplary embodiment may set a reminder in the issue occurrence information.

Specifically, the server may set the reminder in the issue occurrence information according to reminder date information for the issue occurrence information received from the manager terminal. Since the details related to reminder settings have been described above in 4. Manager Terminal, a duplicate description will be omitted.

The server according to one exemplary embodiment may store an additional message in the issue occurrence information.

Specifically, the server may store, in the issue occurrence information, the additional message regarding the issue occurrence information received from the manager terminal. In addition, the server may store the additional message in the issue occurrence information according to the reclassification of the issue occurrence information. Since the details related to the additional messages have been described above in 4. Manager Terminal, a duplicate description will be omitted.

### 6. Operating Issue Management System

The following describes the operation of an issue management system according to one exemplary embodiment.

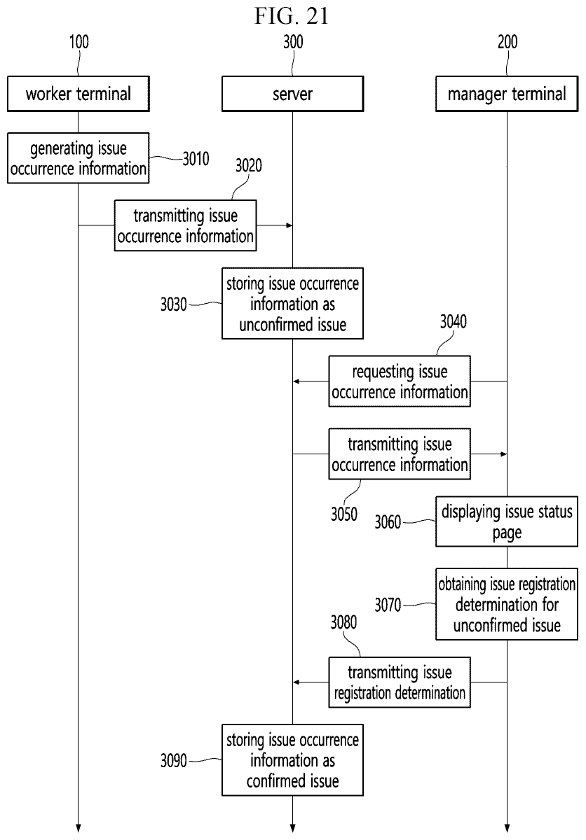

FIG. 21 is a flowchart illustrating an issue management method according to one exemplary embodiment.

Referring to FIG. 21, a worker terminal 100 may perform a step 3010 of generating issue occurrence information according to a user's input and perform a step 3020 of transmitting the issue occurrence information to a server 300. The specific details regarding the issue occurrence information, generation of the issue occurrence information, and transmission of the issue occurrence information have been described above, so a duplicate description will be omitted.

The server 300 may perform a step 3030 of classifying, as an unconfirmed issue, and storing the issue occurrence information received from the worker terminal 100. The specific details regarding the unconfirmed issue and the classification into the unconfirmed issue have been described above, so a duplicate description will be omitted.

A manager terminal 200 may perform a step 3040 of requesting the issue occurrence information from the server 300, and the server 300 may perform a step 3050 of transmitting the issue occurrence information to the manager terminal 200 according to the request of the manager terminal 200. The specific details regarding requesting and transmitting the issue occurrence information have been described above, so a duplicate description will be omitted.

The manager terminal 200 may perform a step 3060 of displaying an issue status page reflecting the received issue occurrence information. The specific details regarding the issue status page have been described above, so a duplicate description will be omitted.

The manager terminal 200 may perform a step 3070 of obtaining an issue registration determination for the unconfirmed issue through a user input. The specific details of the issue registration determination have been described above, so a duplicate description will be omitted.

The manager terminal 200 may perform a step 3080 of transmitting the obtained issue registration determination to the server 300, and the server 300 may perform a step 3090 of reclassifying, as a confirmed and registered issue, and storing the issue occurrence information. The specific details of the reclassification of the issue occurrence information have been described above, so a duplicate description will be omitted.

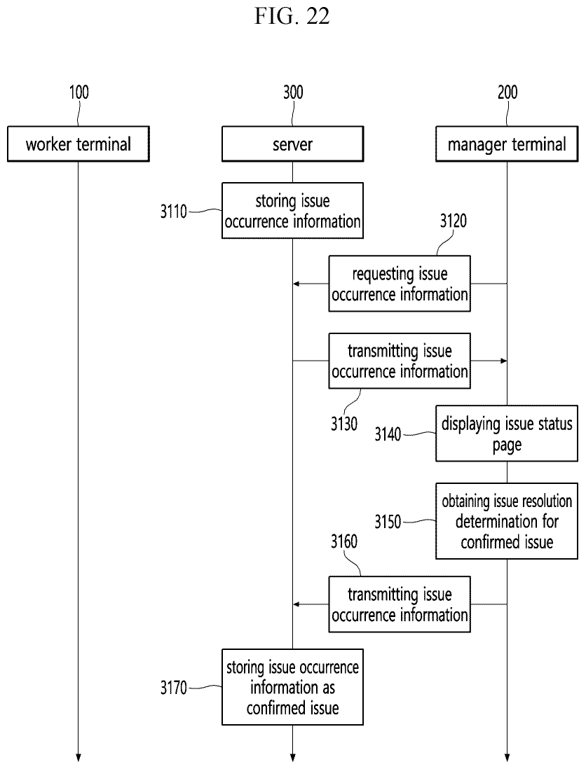

FIG. 22 is a flowchart illustrating an issue management method according to one exemplary embodiment.

Referring to FIG. 22, the server 300 may perform a step 3110 of storing the issue occurrence information. The issue occurrence information may be information received from the worker terminal 100 and/or the manager terminal 200. The specific details regarding the issue occurrence information have been described above, so a duplicate description will be omitted.

The manager terminal 200 may perform a step 3120 of requesting the issue occurrence information from the server 300, and the server 300 may perform a step 3130 of transmitting the issue occurrence information to the manager terminal 200 according to the request of the manager terminal 200. The specific details regarding requesting and transmitting the issue occurrence information have been described above, so a duplicate description will be omitted.

The manager terminal 200 may perform a step 3140 of displaying an issue status page reflecting the received issue occurrence information. The specific details regarding the issue status page have been described above, so a duplicate description will be omitted.

The manager terminal 200 may perform a step 3150 of obtaining an issue resolution determination for the confirmed and registered issue through a user input. The specific details of the issue resolution determination have been described above, so a duplicate description will be omitted.

The manager terminal 200 may perform a step 3160 of transmitting the obtained issue resolution determination to the server 300, and the server 300 may perform a step 3170 of reclassify, as a resolved issue, and storying the issue occurrence information. The specific details of the reclassification of the issue occurrence information have been described above, so a duplicate description will be omitted.

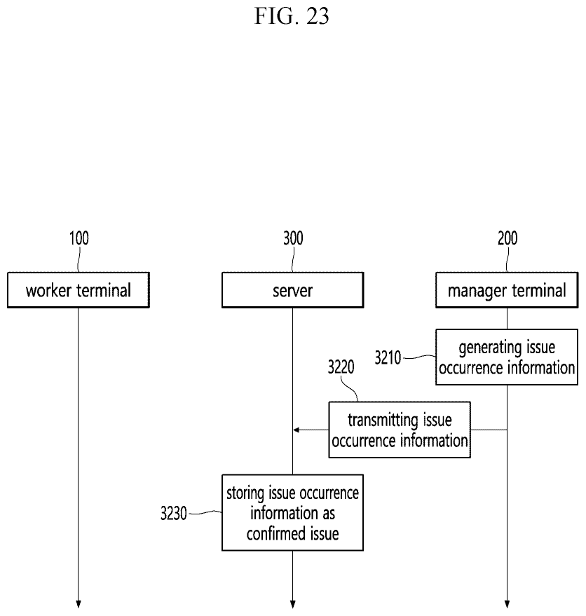

FIG. 23 is a flowchart illustrating an issue management method according to one exemplary embodiment.

Referring to FIG. 23, the manager terminal 200 may perform a step 3210 of generating issue occurrence information according to a user input and perform a step 3220 of transmitting the issue occurrence information to the server 300. The specific details regarding the issue occurrence information, generation of the issue occurrence information, and transmission of the issue occurrence information have been described above, so a duplicate description will be omitted.

The server 300 may perform a step 3230 of classifying, as a confirmed and registered issue, and storing the issue occurrence information received from the manager terminal 200. The specific details regarding the confirmed and registered issue have been described above, so a duplicate description will be omitted.

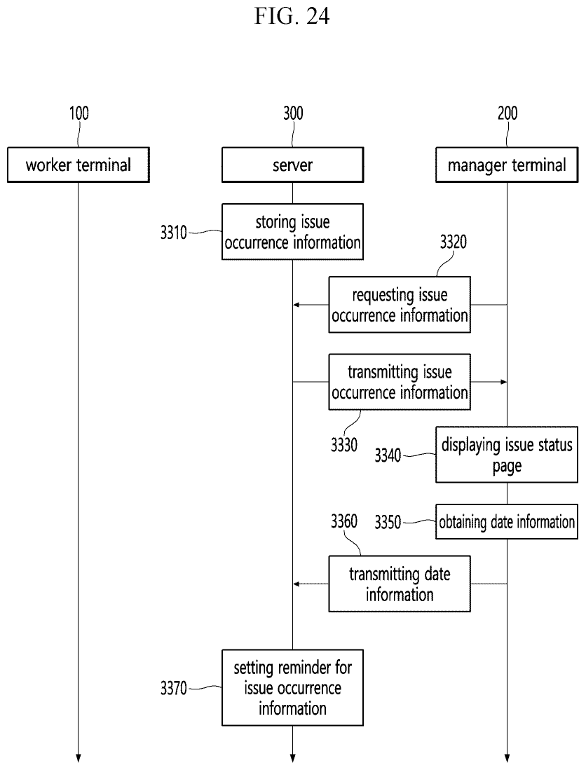

FIG. 24 is a flowchart illustrating an issue management method according to one exemplary embodiment.

Referring to FIG. 24, the server 300 may perform a step 3310 of storing issue occurrence information. The issue occurrence information may be information received from the worker terminal 100 and/or the manager terminal 200. The specific details regarding the issue occurrence information have been described above, so a duplicate description will be omitted.

The manager terminal 200 may perform a step 3320 of requesting the issue occurrence information from the server 300, and the server 300 may perform a step 3330 of transmitting the issue occurrence information to the manager terminal 200 according to the request of the manager terminal 200. The specific details regarding requesting and transmitting the issue occurrence information have been described above, so a duplicate description will be omitted.

The manager terminal 200 may perform a step 3340 of displaying an issue status page reflecting the received issue occurrence information. The specific details regarding the issue status page have been described above, so a duplicate description will be omitted.

The manager terminal 200 may perform a step 3350 of obtaining date information for reminder settings through a user input and perform a step 3360 of transmitting the date information to the server 300, and the server 300 may perform a step 3370 of setting a reminder for the issue occurrence information according to the obtained date information. The specific details regarding the reminder settings have been described above, so a duplicate description will be omitted.

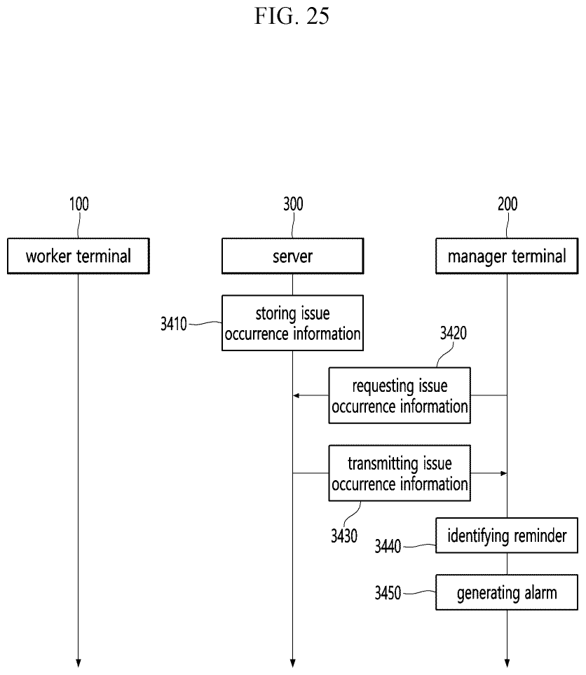

FIG. 25 is a flowchart illustrating an issue management method according to one exemplary embodiment.

Referring to FIG. 25, the server 300 may perform a step 3410 of storing issue occurrence information. The issue occurrence information may be information received from the worker terminal 100 and/or the manager terminal 200. The specific details regarding the issue occurrence information have been described above, so a duplicate description will be omitted.

The manager terminal 200 may perform a step 3420 of requesting the issue occurrence information from the server 300, and the server 300 may perform a step 3430 of transmitting the issue occurrence information to the manager terminal 200 according to the request of the manager terminal 200. The specific details regarding requesting and transmitting the issue occurrence information have been described above, so a duplicate description will be omitted.

The manager terminal 200 may perform a step 3440 of identifying whether there is issue occurrence information with a reminder that is set and includes reminder date information corresponding to the current date in the issue occurrence information. The manager terminal 200 may perform a step 3450 of generating an alarm when there is the issue occurrence information with the reminder that is set and includes the reminder date information corresponding to the current date in the issue occurrence information. Specific details regarding the reminder identification and alarm generation have been described above, so a duplicate description will be omitted.

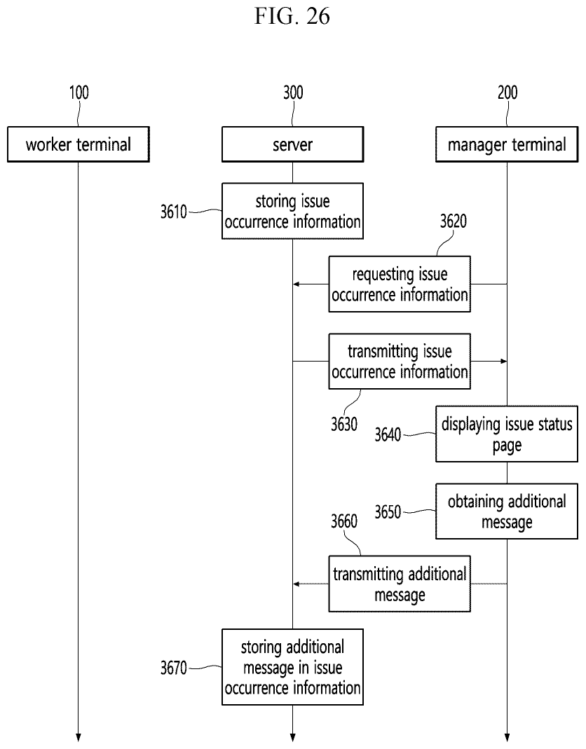

FIG. 26 is a flowchart illustrating an issue management method according to one exemplary embodiment.

Referring to FIG. 26, the server 300 may perform a step 3610 of storing issue occurrence information. The issue occurrence information may be information received from the worker terminal 100 and/or the manager terminal 200. The specific details regarding the issue occurrence information have been described above, so a duplicate description will be omitted.

The manager terminal 200 may perform a step 3620 of requesting the issue occurrence information from the server 300, and the server 300 may perform a step 3630 of transmitting the issue occurrence information to the manager terminal 200 according to the request of the manager terminal 200. The specific details regarding requesting and transmitting the issue occurrence information have been described above, so a duplicate description will be omitted.

The manager terminal 200 may perform a step 3640 of displaying an issue status page reflecting the received issue occurrence information. The specific details regarding the issue status page have been described above, so a duplicate description will be omitted.

The manager terminal 200 may perform a step 3650 of obtaining an additional message through a user input and perform a step 3660 of transmitting the additional message to the server 300, and the server 300 may perform a step 3670 of storing the obtained additional message in the issue occurrence information. The specific details of obtaining and storing the additional message have been described above, so a duplicate description will be omitted.

The system and/or methods according to the exemplary embodiment may be implemented in the form of program instructions executable through various computer means, and be recorded in a computer-readable media.

The computer-readable media may include program instructions, data files, data structures, and the like alone or in combination thereof.

The program instructions recorded on the computer-readable recording media may be designed and configured specifically for the exemplary embodiments or may be publicly known and available to those skilled in the art regarding computer software.

Examples of the computer-readable recording media include a magnetic medium such as a hard disk, a floppy disk, and a magnetic tape, an optical medium such as a CD-ROM, a DVD, a magneto-optical medium such as a floptical disk, and a hardware device specially configured to store and perform program instructions, the hardware device including a read-only memory (ROM), a random access memory (RAM), a flash memory, etc.

Examples of the computer instructions include not only machine language code generated by a compiler, but also high-level language code executable by a computer using an interpreter or the like.

The hardware device described above may be configured to operate by one or more software modules to perform the operations of the exemplary embodiments, and vice versa.

The present disclosure described above is capable of various substitutions, modifications, and changes without departing from a scope of the technical idea of the present disclosure for those skilled in the art to which the present disclosure pertains. so the present disclosure is not limited by the above-described exemplary embodiments and attached drawings. In addition, the exemplary embodiments described in the present document are not intended to be limited in application, but all or part of each of the exemplary embodiments may also be selectively combined and configured so that various modifications may be made. Furthermore, the steps constituting each exemplary embodiment may be used individually or in combination with the steps constituting other exemplary embodiments.

1. An issue management system comprising a manager terminal, a worker terminal, and a server, the system comprising:
at least one worker terminal assigned to a worker who is guided to perform work within a greenhouse according to a preset schedule;
at least one manager terminal assigned to a manager who oversees a state of the work within the greenhouse and a progress of the work within the greenhouse; and
the server communicatively connected to the worker terminal and the manager terminal and configured to store and manage information about the greenhouse,
wherein the worker terminal is configured to transmit first issue occurrence information generated according to a first input of a user to the server,
the first issue occurrence information at least comprises one of a type of issue, an occurrence location of an issue, a photo related to the issue, and urgency status of the issue,
the first input is obtained through an issue input interface provided on the worker terminal,
the server is configured to store the first issue occurrence information received from the at least one worker terminal, classify, as an unconfirmed issue, and store the first issue occurrence information until an issue registration determination for the first issue occurrence information is received from the manager terminal, and provide one or more pieces of the stored issue occurrence information to the manager terminal in response to a trigger received from the manager terminal,
the manager terminal is configured to display an issue occurrence status page reflecting the one or more pieces of the provided issue occurrence information,
one or more issue items representing the one or more pieces of the issue occurrence information are displayed on the issue occurrence status page,
the one or more issue items are classified and displayed according to the type,
an issue item indicating issue occurrence information classified as the unconfirmed issue is classified, as the unconfirmed issue, and displayed despite the type, and
an issue item indicating issue occurrence information comprising an urgency is displayed along with an urgency indicator indicating the urgency.

2. The issue management system of claim 1, wherein when a first issue item based on a second input of the user is selected, the manager terminal displays an issue detail page for the first issue item, and
the issue detail page displays the type, the occurrence location, and the photo, which are corresponding to the selected first issue item.

3. The issue management system of claim 2, wherein when the first issue item is an issue item classified as the unconfirmed issue, the issue detail page is further provided with an issue registration interface,
the manager terminal transmits an issue registration determination to the server when obtaining the issue registration determination for the first issue item through the issue registration interface, and
the server reclassifies, as a registered issue, the issue occurrence information classified as the unconfirmed issue corresponding to the first issue item.

4. The issue management system of claim 3, wherein when the first issue item is an issue item indicating issue occurrence information classified as the registered issue, the issue detail page is further provided with an issue resolution interface,
the manager terminal transmits an issue resolution determination to the server when obtaining the issue resolution determination for the first issue item through the issue resolution interface, and
the server reclassifies, as a resolved issue, the issue occurrence information classified as the registered issue corresponding to the first issue item.

5. The issue management system of claim 4, wherein the issue items indicating the issue occurrence information classified as the resolved issue is classified as the resolved issue and displayed on the issue occurrence status page despite the type.

6. The issue management system of claim 1, wherein the manager terminal transmits second issue occurrence information generated according to a third input of the user to the server,
the second issue occurrence information comprises at least the type of issue and the occurrence location of the issue,
the third input is obtained through the issue input interface provided on the manager terminal, and
the server stores the second issue occurrence information received from the manager terminal, but classifies, as the registered issue, and stores the second issue occurrence information even though the issue registration determination for the second issue occurrence information is not received.

7. The issue management system of claim 1, wherein the issue input interface comprises:
an occurrence location selection interface of the issue;
a type selection interface of the issue;
a photo input interface related to the issue;
an urgency selection interface of the issue; and
a description input interface related to the issue.

8. The issue management system of claim 7, wherein the interface for selecting the occurrence location is deactivated when there is location information corresponding to a QR code obtained through the worker terminal.

9. The issue management system of claim 7, wherein the occurrence location selection interface is provided to display a preset list of locations so that one of the locations is selected.

10. The issue management system of claim 7, wherein the occurrence location selection interface comprises at least one of:
a zone selection interface provided to display preset zone tabs so that one of the zone tabs is selected;
a line selection interface provided to display a preset list of lines existing within a zone so that one of the lines existing within the zone is selected; and
a line-based location selection interface provided to display preset approximate location tabs within a line so that one of the approximate location tabs within the line is selected.

11. The issue management system of claim 7, wherein the type selection interface is provided to display preset issue type tabs so that one of the issue type tabs is selected,
the photo input interface is provided to input the photo obtained from a photographing module of the worker terminal,
the urgency selection interface is provided to display preset urgency setting tabs so that one of the urgency setting tabs is selected, and
the description input interface is provided to input a message through an input unit of the worker terminal.

12. The issue management system of claim 1, wherein the type at least comprises pests and diseases, as well as facility failures, and
an issue item indicating issue occurrence information classified as unconfirmed, an issue item indicating issue occurrence information regarding the pests and diseases, and an issue item indicating issue occurrence information regarding the facility failures are classified and displayed in the issue occurrence status page.

13. The issue management system of claim 1, wherein among the one or more pieces of the issue occurrence information, a number of pieces of the issue occurrence information classified as the unconfirmed issue and the number of pieces of the issue occurrence information by type are classified and displayed in the issue occurrence status page.

14. The issue management system of claim 1, wherein the occurrence location is classified for each zone within the greenhouse, and
the one or more issue items are classified and displayed for each zone in the issue occurrence status page.

15. The issue management system of claim 1, wherein the issue occurrence information further comprises a generation date of the issue, and
the issue occurrence status page separately displays an issue item indicating issue occurrence information comprising the urgency and whose generation date is a current date, among the one or more pieces of the issue occurrence information.

16. The issue management system of claim 1, wherein the manager terminal displays an issue detail page for a second issue item when the second issue item is selected according to a fourth input of the user,
the issue detail page is provided with a reminder settings interface,
the manager terminal transmits reminder date information to the server when obtaining the reminder date information for the second issue item through the reminder settings interface, and
the server sets a reminder comprising the reminder date information in the issue occurrence information corresponding to the second issue item.

17. The issue management system of claim 16, wherein in the issue occurrence status page, a reminder indicator is displayed together with an issue item indicating issue occurrence information for which the reminder is set.

18. The issue management system of claim 16, wherein the manager terminal provides an alarm when there is issue occurrence information, for which the reminder is set and comprising the reminder date information corresponding to the current date, among the one or more pieces of the issue occurrence information.

19. The issue management system of claim 1, wherein the manager terminal displays an issue detail page for a third issue item when the third issue item is selected according to a fifth input of the user,
the issue detail page is provided with a message input interface,
the manager terminal transmits an additional message to the server when obtaining the additional message for the third issue item through the message input interface, and
the server comprises the additional message in issue occurrence information corresponding to the third issue item.

20. The issue management system of claim 19, wherein the issue detail page displays the additional message included in the issue occurrence information corresponding to the third issue item.
